(19) United States
(12) Patent Application Publication
(10) Pub. No.: US 2020/0217262 A1
(43) Pub. Date: Jul. 9, 2020

(54) ENGINE SYSTEM

(71) Applicant: AISAN KOGYO KABUSHIKI KAISHA, Obu-shi, Aichi-ken (JP)

(72) Inventor: Mamoru YOSHIOKA, Nagoya-shi (JP)

(73) Assignee: AISAN KOGYO KABUSHIKI KAISHA, Obu-shi, Aichi-ken (JP)

(21) Appl. No.: 16/642,072

(22) PCT Filed: Jul. 3, 2018
(86) PCT No.: PCT/JP2018/025136

§ 371 Date: Feb. 26, 2020

(30) Foreign Application Priority Data
Sep. 20, 2017 (JP) 2017-180533

(51) Int. Cl. F02D 41/12; F02D 43/00; F02B 37/00; F02M 25/08

(52) U.S. Cl. CPC F02D 41/12; F02M 25/08; F02B 37/00; F02D 43/00

(57) ABSTRACT

This engine system is provided with: an engine; an injector; a super charger (including a compressor); an electronic throttle device provided in an air intake passage, the compressor being provided in the air intake passage upstream of the electronic throttle device; an evaporated fuel treatment apparatus (including a canister, a purge passage, and a purge valve), an outlet of the purge passage being connected to the air intake passage upstream of the compressor; and an electronic control unit (ECU). The ECU controls the purge valve in order to perform a purge cut of the vapor from the purge passage toward the air intake passage when determining that the engine has started to decelerate, and thereafter controls the injector in order to perform fuel cut to the engine.

### TECHNICAL FIELD

The technique disclosed in this specification relates to an engine system including an engine equipped with a supercharger, an intake air amount regulating valve for regulating an intake air amount of the engine, and an evaporated fuel treatment apparatus for treating evaporated fuel generated in a fuel tank, the engine system being configured to control the intake air amount regulating valve and the evaporated fuel treatment apparatus during deceleration of the engine.

### BACKGROUND ART

Conventionally, as a technique of the above type, for example, there has been known an “internal combustion engine equipped with a supercharger” described in Patent Document 1 described below. This technique includes an engine equipped with a supercharger, an electronic throttle device for adjusting an intake air amount of the engine, a fresh air introduction device for introducing fresh air downstream of the electronic throttle device (including a fresh air introduction passage and a fresh air introduction valve), an EGR device (including an EGR passage and an EGR valve) for recirculating a part of exhaust gas discharged from the engine to the engine as EGR gas, and a leakage EGR bypass passage branching from the fresh air introduction passage. In this configuration, when EGR gas leaks from the intake passage downstream of the electronic throttle device to the fresh air introduction passage, the leaking EGR gas is scavenged to the intake passage upstream of an outlet of the EGR passage via the leakage EGR bypass passage, thereby maintaining the function of the fresh air introduction valve.

### RELATED ART DOCUMENTS

### Patent Documents

Patent Document 1: Japanese unexamined patent application publication No. 2015-40549

### SUMMARY OF INVENTION

### Problems to be Solved by the Disclosure

Meanwhile, it is conceivable that the technique described in Patent Document 1 is provided with an evaporated fuel treatment apparatus (including a canister, a purge passage, and a purge valve) for treating evaporated fuel (vapor) generated in a fuel tank. In this case, in the supercharger-equipped engine, the outlet of the purge passage for directing the vapor flowing out of the canister to flow in the intake passage is often provided in the intake passage upstream of the supercharger (a compressor). In this case, the path of the intake passage from the outlet of the purge passage to the engine is apt to be long and the volume of the intake passage tends to be large. Herein, generally, fuel supply to the engine may be cut off (Fuel cut) when the engine is decelerated. Usually, purging of the vapor from the purge passage to the intake passage is also cut off (Purge cut) simultaneously with the fuel cut. This is to avoid a circumstance that if purging of the vapor continues during execution of the fuel cut, the vapor (including unburned fuel) may also flow to a catalyst in the exhaust passage through the engine and thus the temperature of the catalyst may excessively rise.

However, in the foregoing engine system in which the supercharger-equipped engine is provided with the evaporated fuel processing apparatus, when the electronic throttle device is closed to a predetermined opening degree for deceleration (“deceleration opening degree”) during deceleration of the engine, a large amount of intake air containing the vapor remains in the intake passage upstream of the electronic throttle device, and the residual intake air may flow into the engine through the electronic throttle device that opens at a minute opening degree and further flow into the catalyst. Therefore, even if purge cut is performed at the same time as fuel cut during deceleration, residual intake air containing vapor continues to flow into the catalyst, thereby causing an excessive rise of the temperature of the catalyst, resulting in such an overheat that the catalyst is deteriorated or eroded.

The present disclosure has been made in view of the aforementioned circumstances and has a purpose to provide an engine system including an intake amount regulating valve provided in an intake passage downstream of a supercharger, and an evaporated fuel treatment apparatus for purging evaporated fuel generated in a fuel tank to an intake passage upstream of the supercharger, the engine system being configured to avoid inflow of the evaporated fuel from the engine to the catalyst to prevent the catalyst from excessive rising in temperature when the fuel cut is performed during deceleration of the engine.

### Means of Solving the Problems

(1) To achieve the above purpose, one aspect of the disclosure provides an engine system comprising: an engine; an intake passage configured to introduce intake air into the engine; an exhaust passage configured to discharge exhaust gas from the engine; a fuel supply device including a fuel tank for storing fuel and an injector for injecting the fuel stored in the fuel tank, the fuel supply device being configured to supply the fuel to the engine; an intake amount regulating valve placed in the intake passage and configured to regulate an amount of the intake air flowing through the intake passage; a supercharger including a compressor placed in the intake passage, a turbine placed in the exhaust passage, and a rotary shaft connecting the compressor and the turbine in an integrally rotatable manner, the supercharger being configured to increase pressure of the intake air in the intake passage; an evaporated fuel treatment apparatus comprising: a canister configured to temporarily collect evaporated fuel generated in the fuel tank; a purge passage configured to purge the evaporated fuel collected in the canister to the intake passage, the purge passage having an outlet connected to the intake passage upstream of the compressor; and a purge regulating unit configured to regulate an amount of the evaporated fuel to be purged from the purge passage to the intake passage, the evaporated fuel treatment apparatus being configured to treat the evaporated fuel; an operating-state detecting unit configured to detect an operating state of the engine; and a controller configured to control at least the injector, the intake amount regulating valve, and the purge regulating unit according to the detected operating state of the engine, wherein, during operation of the engine, when the controller determines that the engine has started to decelerate based on the detected operating state of the engine, the controller is configured to control the purge regulating unit to cut off purging of the evaporated fuel from the purge passage to the intake passage and then control the injector to cut off supply of the fuel to the engine.

According to the above configuration (1), during deceleration of the engine in which the fuel injected from the injector is supplied to the engine and the evaporated fuel is purged from the purge passage to the intake passage, the intake amount regulating valve is closed from a valve open state to a deceleration opening degree and, from the start of deceleration, the intake air containing the evaporated fuel remains in the intake passage upstream of the intake amount regulating valve. This residual intake air may flow to the engine through a minute opening degree of the intake amount regulating valve and hence flow into the catalyst in the exhaust passage. Herein, when the engine is determined to have started to decelerate, purging of the evaporated fuel is cut off (“purge cut”) first and then supply of the fuel is cut off (“fuel cut”). Thus, the purge cut is performed prior to execution of the fuel cut and, by the time when the fuel cut is performed, the residual intake air containing evaporated fuel upstream of the intake amount regulating valve is flowed and scavenged to the engine and then combusted in the engine. Thus, there is no evaporated fuel which may flow to the catalyst after the fuel cut is performed.

(2) To achieve the above purpose, in the foregoing configuration (1), after controlling the purge adjusting unit to cut off purging of the evaporated fuel, the controller is configured to control the injector to cut off supply of the fuel when determining that the engine has reached a predetermined operating state.

According to the above configuration (2), in addition to the operations of the above configuration (1), the fuel cut is performed when the engine reaches a predetermined operating state after the purge cut is performed.

(3) To achieve the above purpose, in the foregoing configuration (1) or (2), after controlling the purge adjusting unit to cut off purging of the evaporated fuel, the controller is configured to obtain an amount of residual intake air containing the evaporated fuel remaining in the intake passage upstream of the intake amount regulating valve based on the detected operating state, and control the injector to cut off supply of the fuel when determining that the obtained amount of the residual intake air is completely scavenged.

According to the above configuration (3), in addition to the operations of the above configuration (1) or (2), after execution of the purge cut of the evaporated fuel, the amount of residual intake air containing the evaporated fuel remaining in the intake passage upstream of the intake amount regulating valve is obtained and, after the obtained amount of residual intake air is completely scavenged, the fuel cut is performed. Thus, after the purge cut is executed and the residual intake air containing the evaporated fuel is reliably cleared out of the intake passage upstream of the intake amount regulating valve, the fuel cut is performed.

(4) To achieve the above purpose, in the foregoing configuration (1) or (2), the controller is configured to estimate a temperature of the catalyst based on the detected operating state of the engine when determining that the engine has started to decelerate during operation of the engine, and control the purge regulating unit to cut off purging of the evaporated fuel when the estimated temperature of the catalyst rises higher than a predetermined reference temperature.

According to the above configuration (4), in addition to the operations of the above configuration (1) or (2), overheating of the catalyst will be problematic mainly when the temperature of the catalyst is higher than the predetermined reference temperature. Herein, the purge cut of the evaporated fuel is performed when the estimated temperature of the catalyst becomes higher than the predetermined reference temperature. Thus, the purge cut is performed according to the temperature state of the catalyst.

(5) To achieve the above purpose, in the foregoing configuration (1) or (2), the operating-state detecting unit includes an air-fuel ratio detecting unit configured to detect an air-fuel ratio of the engine, and the controller is configured to obtain a delay time for delaying cut-off of purging of the evaporated fuel based on a change in the detected air-fuel ratio and control the purge regulating unit to cut off purging of the evaporated fuel after a lapse of the delay time when determining that the engine has started to decelerate during operation of the engine.

According to the above configuration (5), in addition to the operations of the above configuration (1) or (2), the timing at which the temperature of the catalyst rises due to inflow of the evaporated fuel is predicted by the delay time obtained based on the change in air-fuel ratio of the engine. After a lapse of the delay time, the purge cut of the evaporated fuel is executed. Therefore, the timing to execute the purge cut is adjusted according to the timing of the temperature rise of the catalyst.

(6) To achieve the above purpose, in the foregoing configuration (1) or (2), the controller is configured to control the purge regulating unit to gradually decrease a purge rate of the evaporated fuel when purging of the evaporated fuel is to be cut off.

According to the above configuration (6), in addition to the operations of the above configuration (1) or (2), the purge rate is adjusted to gradually decrease when the purge cut of the evaporated fuel is to be performed. Thus, the evaporated fuel which may flow to the engine is not cleared out at once.

(7) To achieve the above purpose, in the foregoing configuration (6), the controller is configured to control the purge regulating unit to gradually increase the purge rate of the evaporated fuel when purging of the evaporated fuel is to be restarted after purging of the evaporated fuel is cut off.

According to the above configuration (7), in addition to the operations of the above configuration (7), the purge rate of the evaporated fuel is adjusted to gradually increase when purging of the evaporated fuel is to be restarted. Thus, the evaporated fuel which may flow to the engine is not increased at once.

(8) To achieve the above purpose, any the foregoing configuration (1) to (7) further comprises an output operation unit to be operated by a driver to control output of the engine, wherein the operating-state detecting unit includes: an output operation amount detecting unit configured to detect an operation amount of the output operation unit; and a valve opening degree detecting unit configured to detect an opening degree of the intake amount regulating valve, and the controller is configured to determine that the engine has started to decelerate based on at least one of a change rate of the detected operation amount and a change rate of the detected opening degree.

According to the above configuration (8), in addition to the operations of any of the above configurations (1) to (7), the start of deceleration of the engine is early determined based on at least one of the change rate of the operation amount of the output operation unit and the change rate of the opening degree of the intake amount regulating valve.

(9) To achieve the above purpose, in the foregoing configuration (8), the controller is configured to control the purge regulating unit to cut off purging of the evaporated fuel when determining both that the engine has started to decelerate based on the change rate of the detected operation amount and that the detected opening degree is smaller than a predetermined small opening degree.

According to the above configuration (9), in addition to the operations of the above configuration (8), when the deceleration of the engine is determined to have started based on the change rate of the operation amount of the output operation unit and further the opening degree of the intake amount regulating valve becomes smaller than the predetermined small opening degree, the purge cut of the evaporated fuel is performed. Thus, the evaporated fuel remaining in the intake passage upstream of the intake amount regulating valve is allowed to flow to the engine until the opening degree of the intake amount regulating valve becomes smaller than the predetermined small opening degree.

(10) To achieve the above purpose, in the foregoing configuration (9), the operating-state detecting unit includes a rotation speed detecting unit configured to detect a rotation speed of the engine, and the controller is configured to set the predetermined small opening degree larger as the detected rotation speed is higher.

According to the above configuration (10), in addition to the operations of the above configuration (9), the amount of evaporated fuel that remains in the intake passage upstream of the intake amount regulating valve and may flow to the engine during deceleration of the engine is larger as the rotation speed of the engine is higher. Herein, when the deceleration of the engine is determined to have started, the predetermined small opening degree which is to be compared with the opening degree of the intake amount regulating valve is set larger as the rotation speed of the engine is higher. Thus, the timing to perform the purge cut is adjusted according to the rotation speed of the engine.

### Effects of the Invention

According to the foregoing configuration (1), in the engine system including: the intake amount regulating valve placed in the intake passage downstream of the supercharger; and the evaporated fuel treatment apparatus for purging the evaporated fuel generated in the fuel tank to the intake passage upstream of the supercharger, it is possible to prevent inflow of the evaporated fuel from the engine to the catalyst when performing the fuel cut during deceleration of the engine. This can prevent an excessive rise of the temperature of the catalyst.

The foregoing configuration (2) can prevent the engine from malfunctioning due to execution of the fuel cut in addition to achieving the effects of the configuration (1).

The foregoing configuration (3) can reliably prevent inflow of the evaporated fuel from the engine to the catalyst when the fuel cut is performed during deceleration of the engine in addition to achieving the effects of the configuration (1) or (2). This can accurately prevent an excessive rise of the temperature of the catalyst.

The foregoing configuration (4) can extend the timing to perform purge cut until the temperature which may lead to overheating of the catalyst in addition to achieving the effects of the configuration (1) or (2). This case can result in an increase in the purge flow rate of the evaporated fuel.

The foregoing configuration (5) can optimize the execution timing of the purge cut according to the temperature of the catalyst in addition to achieving the effects of the configuration (1) or (2). This can both prevent a decrease in purge flow rate and prevent an increase in temperature of the catalyst.

The foregoing configuration (6) can prevent the air-fuel ratio from becoming over-lean or the catalyst temperature from rising due to execution of the purge cut during deceleration of the engine in addition to achieving the effects of the configuration (1) or (2).

The foregoing configuration (7) can prevent the air-fuel ratio from becoming over-rich or the exhaust emission from deteriorating due to purge restarting during operation of the engine in addition to achieving the effects of the configuration (6).

The foregoing configuration (8) can perform the purge cut from an early stage after the start of deceleration of the engine in addition to achieving the effects of any of the configurations (1) to (7). This can prevent a needless increase in amount of evaporated fuel in the intake passage upstream of the intake amount regulating valve.

The foregoing configuration (9) can cause almost all the evaporated fuel remaining in the intake passage upstream of the intake amount regulating valve to be flowed and scavenged to the engine in addition to achieving the effects of the configuration (8). This case can result in an increase in the purge flow rate of the evaporated fuel.

The foregoing configuration (10) can perform the purge cut at an optimal timing at which scavenging of the evaporated fuel remaining upstream of the intake amount regulating valve can be completed in addition to achieving the effects of the configuration (9).

### BRIEF DESCRIPTION OF THE DRAWINGS

FIG. 1 is a schematic configuration view of an engine system in a first embodiment;

FIG. 2 is a schematic cross-sectional view of an engine in the first embodiment;

FIG. 3 is a flowchart showing contents of purge control in the first embodiment;

FIG. 4 is a fuel-cut execution load map to be referred to in order to obtain a fuel-cut execution load according to an engine rotation speed in the first embodiment;

FIG. 5 is a time chart showing behaviors of various parameters in the purge control in the first embodiment;

FIG. 6 is a flowchart showing contents of purge control in a second embodiment;

FIG. 7 is a time chart showing behaviors of various parameters in the purge control in the second embodiment;

FIG. 8 is a flowchart showing contents of purge control in a third embodiment;

FIG. 9 is a small opening degree map to be referred to in order to obtain a small opening degree according to an engine rotation speed in the third embodiment;

FIG. 10 is a flowchart showing contents of purge control in a fourth embodiment;

FIG. 11 is a catalyst temperature rise map to be referred to in order to obtain an increment of catalyst temperature according to an actual injection rate in the fourth embodiment;

FIG. 12 is a flowchart showing contents of purge control in a fifth embodiment;

FIG. 13 is a time chart showing behaviors of various parameters in the purge control in the fifth embodiment;

FIG. 14 is a flowchart showing contents of purge control in a sixth embodiment;

FIG. 15 is an outlet pressure map to be referred to in order to obtain a pressure at a compressor outlet just before deceleration according to the engine rotation speed and the engine load just before deceleration in the sixth embodiment;

FIG. 16 is a graph showing a relationship of a residual intake amount just after deceleration to the compressor outlet pressure just before deceleration in the sixth embodiment;

FIG. 17 is a time chart showing behaviors of various parameters in the purge control in the sixth embodiment;

FIG. 18 is a flowchart showing contents of purge control in a seventh embodiment;

FIG. 19 is a flowchart showing the contents of the purge control in the seventh embodiment; and

FIG. 20 is a time chart showing behaviors of various parameters in the purge control in the seventh embodiment.

### MODE FOR CARRYING OUT THE INVENTION

### First Embodiment

A detailed description of a first embodiment of an engine system embodying the present disclosure will now be given referring to the accompanying drawings.

(Overview of Engine System)

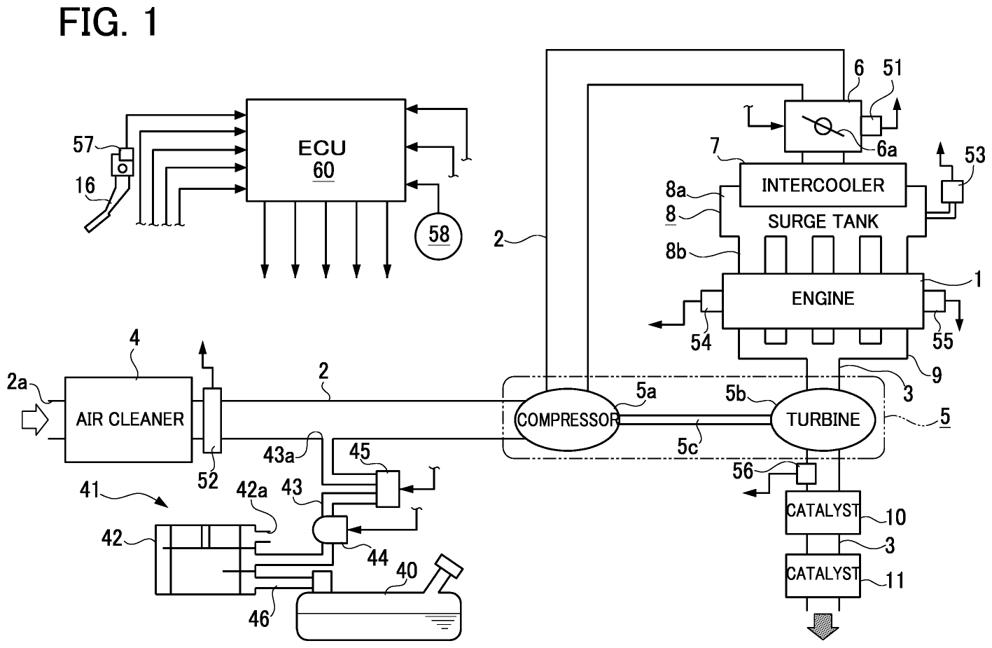

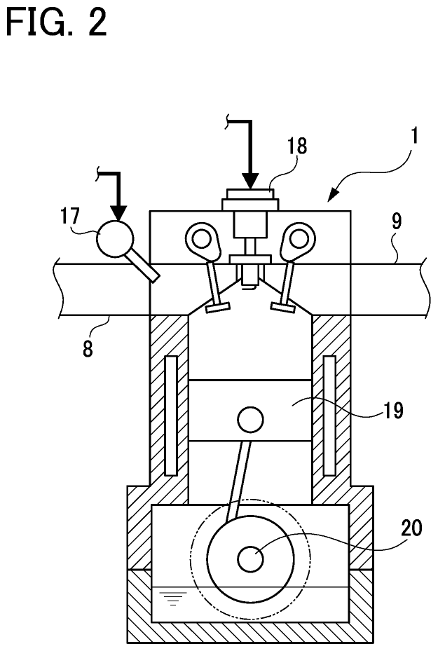

FIG. 1 is a schematic configuration view showing the engine system in the present embodiment. A gasoline engine system installed in an automobile (hereinafter, simply referred to as an “engine system”) includes an engine 1 having a plurality of cylinders. This engine 1 is a four-cylinder, four-cycle reciprocating engine, and includes well-known components, such as a piston 19 and a crankshaft 20 (see FIG. 2) which will be described later. The engine 1 is provided with an intake passage 2 configured to introduce intake air into each of the cylinders, and an exhaust passage 3 configured to discharge exhaust gas from each cylinder. A supercharger 5 is provided in the intake passage 2 and the exhaust passage 3. In the intake passage 2, an intake inlet 2a, an air cleaner 4, a compressor 5a of the supercharger 5, an electronic throttle device 6, an intercooler 7, and an intake manifold 8 are provided in this order from the upstream side.

The electronic throttle device 6 is placed in the intake passage 2 upstream of the intake manifold 8 and the intercooler 7, and is driven to open and close in response to an accelerator operation by a driver, thereby adjusting the amount of intake air flowing through the intake passage 2. For example, the electronic throttle device 6 is constituted of a motor-operated electric valve and includes a throttle valve 6a which is driven to open and close by a motor (not shown), and a throttle sensor 51 configured to detect an opening degree (a throttle opening degree) TA of the throttle valve 6a. The throttle sensor 51 corresponds to one example of a valve opening degree detecting unit in the present disclosure. The electronic throttle device 6 corresponds to one example of an intake amount regulating valve in the present disclosure. The intake manifold 8 is placed immediately upstream of the engine 1 and includes a surge tank 8a into which intake air is introduced and a plurality of (four) branch pipes 8b for distributing the intake air introduced into the surge tank 8a to the cylinders of the engine 1. The exhaust passage 3 is provided with an exhaust manifold 9, a turbine 5b of the supercharger 5, and two catalysts 10 and 11 arranged in series, which are placed in this order from the upstream side. The two catalysts 10 and 11 are used for purifying exhaust gas and can be constituted of, for example, three-way catalyst.

The supercharger 5 is provided to pressurize the intake air in the intake passage 2 and for example includes the compressor 5a arranged in the intake passage 2, the turbine 5b placed in the exhaust passage 3, and a rotary shaft 5c connecting the compressor 5a and the turbine 5b in an integrally rotatable manner. The turbine 5b is rotated by the exhaust gas flowing through the exhaust passage 3. The compressor 5a is rotated in conjunction with the turbine 5b, thus increasing the pressure of the intake air flowing through the intake passage 2. The intercooler 7 is configured to cool the intake air pressurized by the compressor 5a.

FIG. 2 is a schematic cross-sectional view of the engine 1. As shown in FIG. 2, the engine 1 is provided with an injector 17 for injecting fuel for each cylinder. The injector 17 is configured to inject the fuel supplied from a fuel tank 40 (see FIG. 1) storing fuel into each cylinder of the engine 1. In each cylinder, a combustible air-fuel mixture is generated by the fuel injected from the injector 17 and the intake air introduced from the intake manifold 8. The injector 17 and the fuel tank 40 are examples of components constituting a fuel supply device in the present disclosure.

As shown in FIG. 2, the engine 1 is provided with an ignition device 18 for each cylinder. The ignition device 18 is configured to ignite the combustible air-fuel mixture generated in each cylinder. The combustible air-fuel mixture in each cylinder is exploded and combusted by an ignition operation of the ignition device 18, and the exhaust gas after combustion is discharged from each cylinder to the outside through the exhaust manifold 9, the turbine 5b, and each of the catalysts 10 and 11. At that time, in each cylinder, the piston 19 moves up and down and the crankshaft 20 is rotated, thereby generating power in the engine 1.

(Evaporated Fuel Treatment Apparatus)

In this embodiment, as shown in FIG. 1, the fuel supply device includes the fuel tank 40 for storing fuel. This engine system also includes an evaporated fuel treatment apparatus 41 configured to collect and treat the evaporated fuel generated in the fuel tank 40 without releasing the evaporated fuel to atmosphere. This apparatus 41 includes a canister 42, a purge passage 43, a purge pump 44, and a purge valve 45. The canister 42 is configured to temporarily collect the vapor generated in the fuel tank 40 through the vapor passage 46. The canister 42 contains an adsorbent (not shown) for adsorbing the vapor. The purge passage 43 extends from the canister 42 and has an outlet 43a connected to the intake passage 2 upstream of the compressor 5a. As an example, the purge pump 44 and the purge valve 45 each have an electrically-operated configuration and are provided in the purge passage 43. The purge pump 44 is configured to suck the vapor from the canister 42 and discharge the vapor to the purge passage 43. The purge valve 45 is configured to adjust a flow rate of the vapor in the purge passage 43. An air inlet port 42a provided in the canister 42 is arranged to introduce atmospheric air into the canister 42 when the vapor is to be purged into the purge passage 43. The purge pump 44 and the purge valve 45 correspond to one example of a purge adjusting unit in the present disclosure.

According to the evaporated fuel treatment apparatus 41, when a negative pressure generated in the intake passage 2 acts on the canister 42 through the purge passage 43 and others during operation of the engine 1, the purge pump 44 and the purge valve 45 are activated to purge the vapor collected in the canister 42 into the intake passage 2 through the purge passage 43. The purged vapor is thus sucked into the engine 1 and treated by combustion.

(Electric Configuration of Engine System)

As shown in FIG. 1, various sensors 51 to 58 provided in the engine system correspond to one example of an operating-state detecting unit in the present disclosure to detect an operating state of the engine 1. The air flow meter 52 provided near the air cleaner 4 is configured to detect an intake air amount Ga flowing from the air cleaner 4 to the intake passage 2 and output an electric signal representing a detected value thereof. The intake pressure sensor 53 provided in the surge tank 8a is configured to detect an intake pressure PM downstream of the electronic throttle device 6 and output an electric signal representing a detected value thereof. The water temperature sensor 54 provided in the engine 1 is configured to detect a temperature THW of the cooling water flowing inside the engine 1 and output an electric signal representing a detected value thereof. The rotation speed sensor 55 provided in the engine 1 is configured to detect a rotation speed of the crankshaft 20 as a rotation speed NE of the engine 1 and output an electric signal representing a detected value thereof. The rotation speed sensor 55 corresponds to one example of a rotation speed detecting unit in the present disclosure. The oxygen sensor 56 provided in the exhaust passage 3 is configured to detect an oxygen concentration (an output voltage) Ox of the exhaust gas discharged to the exhaust passage 3 and output an electric signal representing a detected value thereof. The oxygen sensor 56 corresponds to one example of an air-fuel ratio detecting unit in the present disclosure. An accelerator pedal 16 placed in a driver's seat is provided with an accelerator sensor 57. The accelerator pedal 16 corresponds to one example of an output operation unit in the present disclosure. The accelerator sensor 57 is configured to detect a depression angle of the accelerator pedal 16 as an accelerator opening degree ACC and output an electric signal representing a detected value thereof. The accelerator sensor 57 corresponds to one example of an output operation amount detecting unit in the present disclosure. The vehicle speed sensor 58 provided in a vehicle is configured to detect a running speed SPD of the vehicle and output an electric signal representing a detected value thereof.

The engine system includes an electronic control unit (ECU) 60 configured to perform various controls. The ECU 60 is connected to each of the various sensors 51 to 58. The ECU 60 is also connected to the electronic throttle device 6, each injector 17, each ignition device 18, the purge pump 44, the purge valve 45, and others. The ECU 60 corresponds to one example of a controller in the present disclosure.

In this embodiment, the ECU 60 is configured to receive various signals output from the various sensors 51 to 58, and control the injectors 17 and the ignition devices 18 in order to perform fuel injection control and ignition timing control including air-fuel ratio control based on these signals. The ECU 60 is also configured to control the electronic throttle device 6, the purge pump 44, and the purge valve 45 in order to perform intake control and purge control based on various signals.

Herein, the intake control is to control the electronic throttle device 6 based on the detection value of the accelerator sensor 57 according to the operation of the accelerator pedal 16 by the driver to adjust the amount of intake air to be sucked into the engine 1. During deceleration of the engine 1, the ECU 60 is configured to control the electronic throttle device 6 (the throttle valve 6a) to close from an open position to a predetermined minute opening degree for deceleration in order to throttle the intake air to be sucked into the engine 1. The purge control is to control the purge pump 44 and the purge valve 45 in accordance with the operating state of the engine 1 to adjust a flow rate of the vapor to be purged from the canister 42 to the intake passage 2.

The ECU 60 includes, as is well known, a central processing unit (CPU), various memories, external input circuits, external output circuits, and others. The memories store predetermined control programs related to various controls of the engine 1. The CPU is configured to perform the above-described various controls according to the predetermined control programs based on the detection values transmitted from the various sensors 51 to 58 via an input circuit.

In the foregoing engine system, the path length of the intake passage 2 from the outlet 43a of the purge passage 43 to the electronic throttle device 6 is relatively long, providing a relatively large path volume. Therefore, when the engine 1 is decelerated from a purge execution state, the throttle valve 6a is closed from the open position to a predetermined deceleration opening degree. At this time, even if the purge cut is executed, the intake air containing the vapor purged before execution of the purge cut remains in a section of the intake passage 2 from the electronic throttle device 6 to the outlet 43a of the purge passage 43 because this section has a relatively long path length. In particular, during deceleration from a supercharged condition, the intake air may become dense and residual intake air containing vapor may flow back to and spread into the upstream side of the compressor 5a. This residual intake air may further flow into the engine 1 through the minute opening degree of the electronic throttle device 6 and then flow into the catalysts 10 and 11. Thus, even if purge cut is performed at the same time as fuel cut during deceleration, residual intake air containing vapor continues to flow into the catalysts 10 and 11, thereby causing the temperature of the catalysts 10 and 11 to excessively rise, which may deteriorate or erode the catalysts 10 and 11. In the present embodiment, therefore, the following purge control is performed in order to address the above-mentioned problems.

(Purge Control During Deceleration)

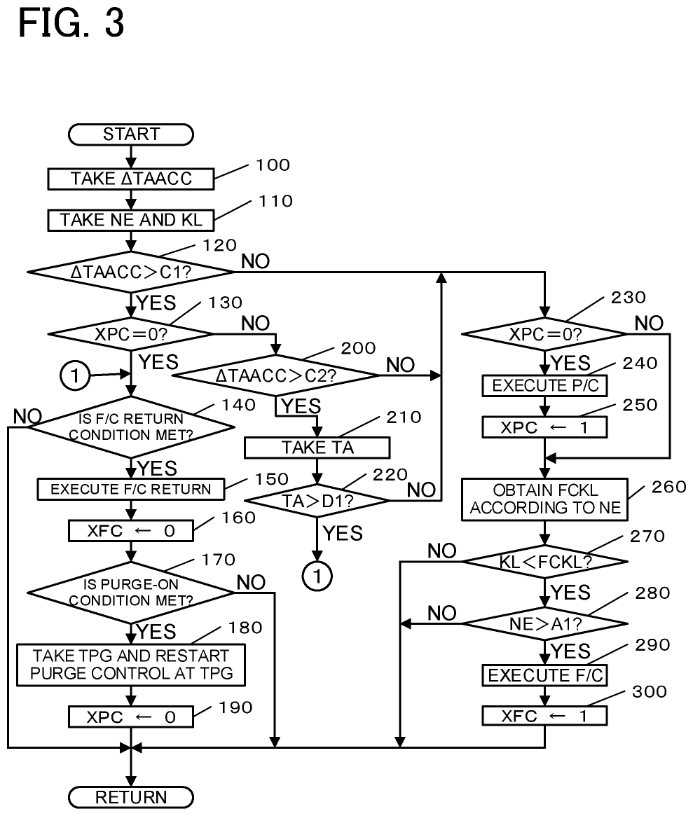

In this embodiment, the following purge control is executed during deceleration of the engine 1. FIG. 3 is a flowchart showing the contents of this control.

When the process proceeds to this routine, the ECU 60 takes an accelerator closing speed ΔTAACC based on the detected value of the accelerator sensor 57. The accelerator closing speed ΔTAACC indicates a change rate of returning the accelerator pedal 16 depressed for a certain opening degree toward a fully closed position for which the pedal 16 is not depressed. The ECU 60 can obtain the accelerator closing speed ΔTAACC based on a change rate of the accelerator opening degree ACC.

In step 110, successively, the ECU 60 takes an engine rotation speed NE and an engine load KL based on the detected values of the intake pressure sensor 53, the rotation speed sensor 55, and others. The ECU 60 can determine the engine load KL from an intake air pressure PM and the engine speed NE.

In step 120, the ECU 60 then determines whether or not the accelerator closing speed ΔTAACC is greater than a first deceleration determination value C1. This first deceleration determination value C1 is set at a predetermined value to early determine deceleration of the engine 1. If the determination result is affirmative, the ECU 60 can determine that the engine 1 has not started to decelerate, and the process proceeds to step 130. If the determination result is negative, the ECU 60 can judge that the engine 1 has started to decelerate, and advances the process to step 230.

In step 130, the ECU 60 determines whether or not a purge-cut execution flag XPC is 0. As will be described later, the purge cut execution flag XPC is set to 1 when the purge cut (P/C) is being executed. If this determination result is affirmative, the ECU 60 can determine that the purge cut is not in execution, and advances the process to step 140. If the determination result is negative, the ECU 60 can determine that the purge cut is in execution, and shifts the process to step 200.

In step 140, the ECU 60 determines whether or not a predetermined fuel-cut return condition required to perform the fuel cut (F/C) is met. The ECU 60 advances the process to step 150 when the determination result is affirmative, but returns the process to step 100 when the determination result is negative.

In step 150, the ECU 60 performs the fuel cut (F/C) return. Specifically, the ECU 60 controls the injector 17 to return from the fuel cut to a normal fuel injection control.

Next, in step 160, the ECU 60 sets the fuel-cut execution flag XFC to 0 since the fuel cut is not in execution.

In step 170, furthermore, the ECU 60 determines whether or not a predetermined purge-on condition required to perform purging of the vapor is met. If the determination result is affirmative, the ECU 60 advances the process to step 180. In contrast, if the determination result is negative, the ECU 60 returns the process to step 100.

In step 180, the ECU 60 takes a predetermined target purge opening degree TPG and restarts the purge control based on this opening degree TPG. The ECU 60 can obtain the target purge opening degree TPG according to the operating state of the engine 1.

In step 190, the ECU 60 then sets the purge-cut execution flag XPC to 0 and returns the process to step 100.

In step 200 following step 130, in contrast, the ECU 60 determines whether or not the accelerator closing speed ΔTAACC is larger than a second deceleration determination value C2 (C2>C1). Herein, as the accelerator closing speed ΔTAACC, the first deceleration determination value C1 is faster than the second deceleration determination value C2. If the determination result is affirmative, the ECU 60 can determine that the engine 1 has changed to acceleration or steady operation and advances the process to step 210. If the determination result is negative, the ECU 60 can determine that the engine 1 continues to decelerate, and shifts the process to step 230.

In step 210, the ECU 60 takes a throttle opening degree TA based on the detected value of the throttle sensor 51.

In step 220, successively, the ECU 60 determines whether or not the throttle opening degree TA is larger than a predetermined deceleration release determination value D1. If the determination result is affirmative, the ECU 60 can determine that the deceleration of the engine 1 is released, and advances the process to step 140. If the determination result is negative, indicating that the throttle opening degree TA is relatively small, the ECU 60 can thus determine that the engine 1 continues to decelerate, and advances the process to step 230.

In step 230 following step 120, step 200, or step 220, on the other hand, the ECU 60 determines whether or not the purge-cut execution flag XPC is 0. If the determination result is affirmative, the ECU 60 can determine that the purge cut is not in execution, and advances the process to step 240. If the determination result is negative, the ECU 60 can determine that purge cut is being performed, and skips the process to step 260.

In step 240, the ECU 60 performs purge cut P/C. That is, the ECU 60 controls the purge pump 44 and the purge valve 45 to cut off purging of the vapor from the purge passage 43 to the intake passage 2.

In step 250, the ECU 60 sets the purge-cut execution flag XPC to 1.

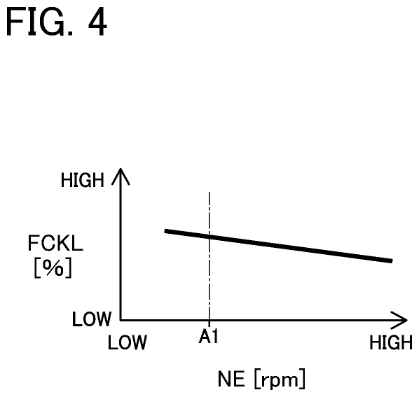

Then, in step 260 following step 230 or step 250, the ECU 60 obtains the engine load KL, that is, a fuel-cut execution load FCKL according to the engine speed NE. The ECU 60 can obtain the fuel-cut execution load FCKL according to the engine speed NE by referring to a fuel-cut execution load map as shown in FIG. 4, for example. In this map, the fuel-cut execution load FCKL is set lower as the engine speed NE is higher.

In step 270, the ECU 60 determines whether or not the current engine load KL is less than the fuel-cut execution load FCKL. If the determination result is affirmative, the ECU 60 advances the process to step 280. If the determination result is negative, the ECU 60 returns the process to step 100.

In step 280, the ECU 60 determines whether or not the engine speed NE is greater than a predetermined value A1. This predetermined value A1 is indicated in the map of FIG. 4. If the determination result is affirmative, indicating that the engine rotation speed NE is relatively high, the ECU 60 advances the process to step 290. If the determination result is negative, indicating that the engine rotation speed NE is relatively low, the ECU 60 returns the process to step 100.

In step 290, the ECU 60 performs the fuel cut (F/C). Specifically, the ECU 60 cuts off fuel injection from the injector 17.

In step 300, the ECU 60 sets the fuel-cut execution flag XFC to 1 and returns the process to step 100.

According to the foregoing purge control, during operation of the engine 1, when the ECU 60 determines that deceleration of the engine 1 has been started based on the detected operating state of the engine 1, the ECU 60 controls the purge pump 44 and the purge valve 45 to cut off the purging of vapor from the purge passage 43 to the intake passage 2 (purge cut), and then controls the injector 17 to cut off the supply of fuel to the engine 1 (fuel cut).

According to the foregoing purge control, after controlling the purge pump 44 and the purge valve 45 to cut off purging of the vapor, when the ECU 60 determines that the engine 1 has reached a predetermined operating state, the ECU 60 controls the injector 17 to perform the fuel cut.

Further, according to the foregoing purge control, the ECU 60 determines that the engine 1 has started to decelerate based on the accelerator closing speed ΔTAACC which is a change rate of the detected accelerator opening degree ACC. When determining that the deceleration has started, the ECU 60 performs the purge cut of the vapor at once. Thereafter, when the accelerator closing speed ΔTAACC lies between the first deceleration determination value C1 and the second deceleration determination value C2, the ECU 60 assumes that the deceleration state continues and thus keeps on executing the purge cut. Further, even if the accelerator closing speed ΔTAACC exceeds the second deceleration determination value C2, unless the accelerator opening degree ACC does not exceed the deceleration release determination value D1, the ECU 60 determines that the deceleration state continues and thus keeps on executing the purge cut. In addition, when returning from the fuel cut while the accelerator opening degree ACC does not exceed the deceleration release determination value D1, the ECU 60 restarts the purge control.

Furthermore, according to the foregoing purge control, when the deceleration of the engine 1 is stopped in the course of deceleration of the engine 1 based on the accelerator closing speed ΔTAACC and the throttle opening degree TA each detected, the ECU 60 controls the purge pump 44 and the purge valve 45 to quickly return the purge rate to a purge rate obtained before the purge cut.

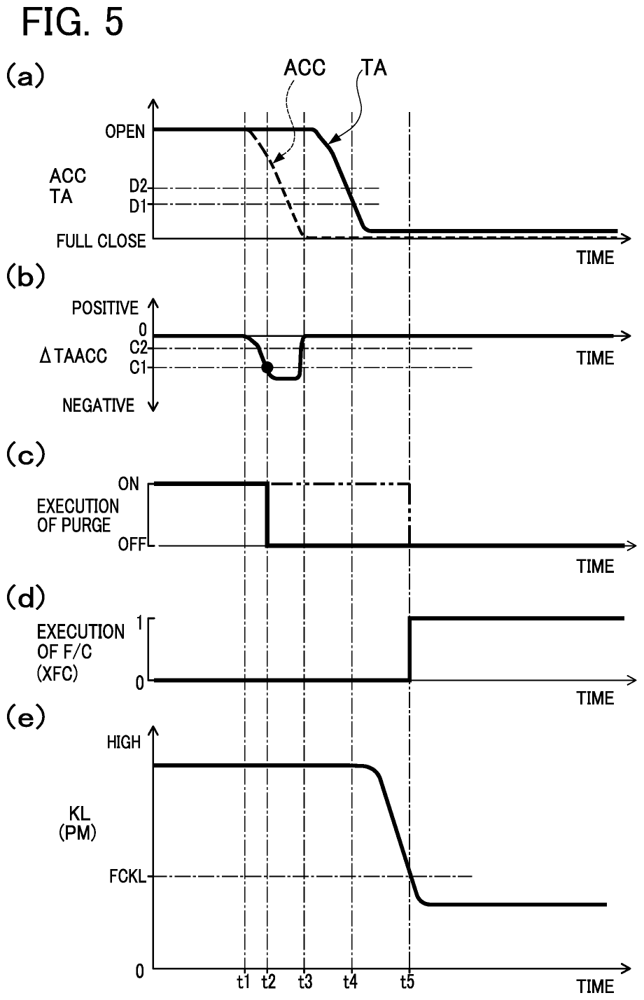

Herein, FIG. 5 is a time chart showing the behaviors of various parameters in the foregoing purge control. In FIG. 5, (a) shows changes in the accelerator opening degree ACC (a broken line) and the throttle opening degree TA (a solid line), (b) shows a change in the accelerator closing speed ΔTAACC, (c) shows a change in the execution of vapor purging (a solid line indicates the present embodiment and a two-dot chain line indicates a conventional example; the same applies to the following description), (d) shows a change in the execution of the fuel cut (F/C) (the fuel-cut execution flag XFC), (e) shows a change in the engine load KL (which is also a change in the intake pressure PM). In FIG. 5, after the accelerator opening degree ACC in (a) starts to decrease at time t1, when the accelerator closing speed ΔTAACC in (b) falls below the first deceleration determination value C1 at time t2, the purge execution in (c) is turned off, that is, the purge cut is performed. Subsequently, after the accelerator opening degree ACC in (a) comes to a full close degree at time t3, the throttle opening degree TA starts to decrease with a delay. Thereafter, when the throttle opening degree TA in (a) falls below the deceleration release determination value D1 at time t4 and then the engine load KL in (e) falls below the fuel-cut execution load FCKL at time t5 while the throttle opening degree TA in (a) having reached a minimum opening degree for deceleration (“minimum deceleration opening degree”) remains thereat, the fuel cut (F/C) in (d) is executed. As seen in FIG. 5, the purge cut is executed at once when the deceleration of the engine 1 is determined to have started based on the change rate of the accelerator opening degree ACC (the accelerator closing speed ΔTAACC) and subsequently the fuel cut is executed when the engine load KL falls below the fuel-cut execution load FCKL while the throttle valve 6a remains closed at the deceleration opening degree.

According to the configuration of the engine system in the present embodiment described above, when the engine 1 is decelerated from the state in which the fuel injected from the injector 17 is supplied to the engine 1 and the vapor is purged from the purge passage 43 to the intake passage 2, the electronic throttle device 6 is closed from the open state to the deceleration opening degree and, from the start of the deceleration, the intake air containing vapor will remain in the intake passage 2 upstream of the electronic throttle device 6. This residual intake air flows to the engine 1 through a minute opening degree of the electronic throttle device 6 and flows to the catalysts 10 and 11 in the exhaust passage 3. Herein, when the engine 1 is determined to have started to decelerate, the purging of vapor is cut off (purge cut) first and the supply of fuel is cut off (fuel cut) later. Thus, the purge cut is performed prior to execution of the fuel cut and, by the time when the fuel cut is performed, the residual intake air containing the vapor in the intake passage 2 upstream of the electronic throttle device 6 is flowed and scavenged to the engine 1 and then combusted in the engine 1. Thus, there is no vapor which may flow to the catalysts 10 and 11 after the fuel cut is performed. In this engine system, therefore, when the fuel cut is performed during deceleration of the engine 1, the inflow of vapor from the engine 1 to the catalysts 10 and 11 can be prevented, the temperature of the catalysts 10 and 11 can be prevented from excessively rising, and the catalysts 10 and 11 can be preventing from deterioration or erosion due to overheating.

According to the configuration of the present embodiment, after the purge cut is performed, the fuel cut is performed when the engine 1 comes into a predetermined operating state (KL<FCKL, NE>A1). This can prevent the engine 1 from malfunctioning due to execution of the fuel cut.

According to the configuration of the present embodiment, the start of deceleration of the engine 1 is determined at an early stage based on at least one of the change rate (the accelerator closing speed ΔTAACC) of the operation amount (the accelerator opening degree ACC) of the accelerator pedal 16 and the change rate of the opening degree (the throttle opening degree TA) of the electronic throttle device 6. Therefore, the purge cut can be performed at an early stage after the start of deceleration of the engine 1, thereby preventing unnecessary increase of vapor in the intake passage 2 upstream of the electronic throttle device 6.

According to the configuration of the present embodiment, when the deceleration is interrupted in the course of deceleration of the engine 1, the purge rate is quickly returned to the purge rate obtained before execution of the purge cut. This can prevent an excessive rise of the catalyst temperature without decreasing the purge flow rate of vapor.

### Second Embodiment

A detailed description of a second embodiment of an engine system embodying the present disclosure will now be given referring to the accompanying drawings.

In the following description, components similar or identical to those in the first embodiment will be assigned the same reference signs as in the first embodiment and their details are omitted. Differences from the first embodiment will be mainly described below.

(Purge Control During Deceleration)

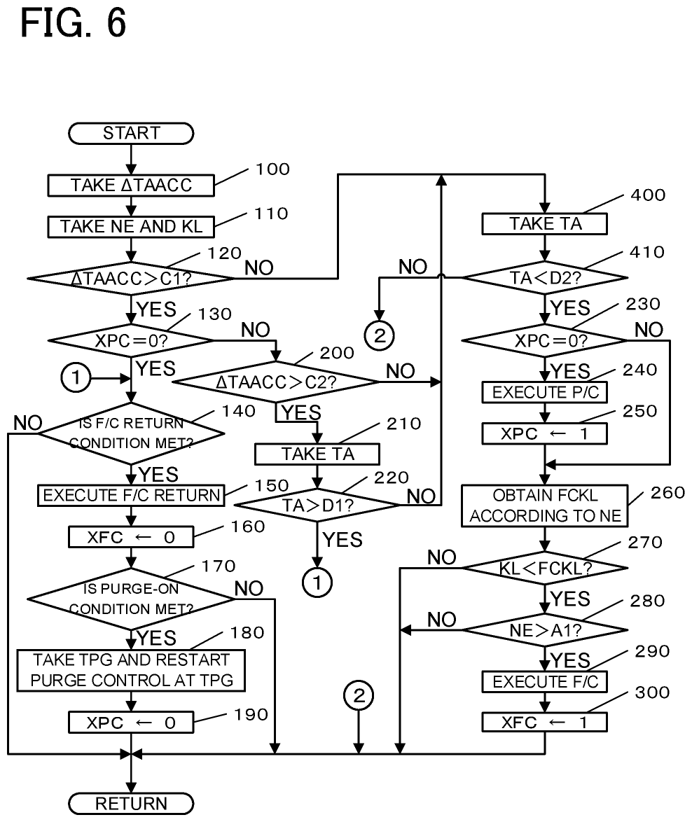

The present embodiment differs in contents of the purge control from the first embodiment. FIG. 6 is a flowchart showing the contents of the purge control.

In the second embodiment, a flowchart in FIG. 6 additionally includes the processes in step 400 and step 410 prior to the process in step 230, differently in configuration from the flowchart in FIG. 3.

Specifically, in this routine, in step 400 following step 120, step 200, or step 220, the ECU 60 takes the throttle opening degree TA based on a detection value of the throttle sensor 51.

In step 410, the ECU 60 determines whether the throttle opening degree TA is smaller than a predetermined small opening degree D2 (D2>D1). In other words, after determining that the engine 1 has started to decelerate based on the accelerator closing speed ΔTAACC in step 120, the ECU 60 waits in step 410 for the throttle valve 6a to close smaller than the predetermined small opening degree D2 after the start of deceleration. If this determination result is affirmative, the ECU 60 shifts the process to step 230 to carry out the vapor purge cut and the fuel cut in sequence. If the determination result is negative, in contrast, the ECU 60 returns the process to step 100.

According to the foregoing purge control, in addition to performing the control of the first embodiment, the ECU 60 is configured to control the purge pump 44 and the purge valve 45 to execute the purge cut of vapor when determining both that the engine 1 has started to decelerate based on the accelerator closing speed ΔTAACC corresponding to a change rate of the detected accelerator opening degree ACC and that the detected throttle opening degree TA is smaller than the predetermined small opening degree D2.

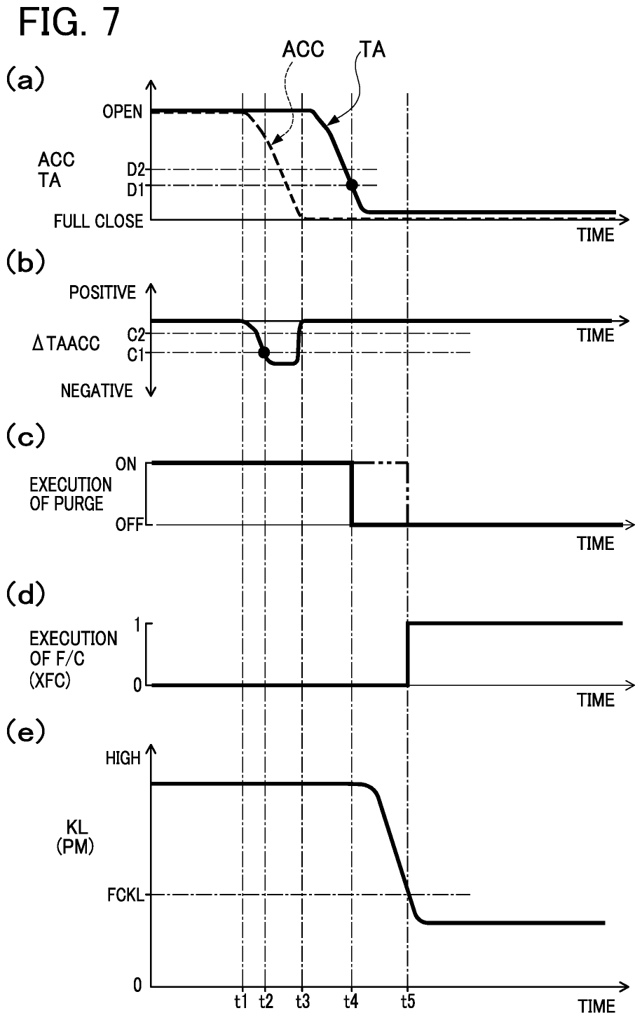

Herein, FIG. 7 shows a time chart of behaviors of various parameters in the foregoing purge control. In FIG. 7, the types of parameters (a) to (e) are the same as those in FIG. 5. In the present embodiment, in FIG. 7, after the accelerator opening degree ACC in (a) starts to decrease at time t1, even when the accelerator closing speed ΔTAACC in (b) falls below the first deceleration determination value C1 at time t2, the purge cut in (c) is not performed, but the purge cut is executed when the throttle opening degree TA in (a) having started to decrease with a delay from when the accelerator opening degree ACC comes to a full close degree falls below the predetermined deceleration release determination value D1 smaller than the predetermined small opening degree D2 at time t4. Thereafter, while the throttle opening degree TA in (a) having reached a minimum deceleration opening degree remains thereat, when the engine load KL in (e) falls below the fuel-cut execution load FCKL at time t5, the fuel cut (F/C) in (d) is executed. As seen in FIG. 7, the purge cut is executed at once after the deceleration of the engine 1 is determined to have started based on the change rate of the accelerator opening degree ACC (the accelerator closing speed ΔTAACC) and further the throttle opening degree TA falls below the predetermined deceleration release determination value D1 and subsequently the fuel cut is executed at once when the engine load KL falls below the fuel-cut execution load FCKL while the throttle valve 6a remains closed at the deceleration opening degree after having been closed thereto with a delay from when the accelerator opening degree ACC has come to the full close degree.

According to the configuration of the engine system in the present embodiment described above, the following operations and effects can be achieved in addition to the operations and effects in the first embodiment. Specifically, when the deceleration of the engine 1 is determined to have started based on the accelerator closing speed ΔTAACC and further the throttle opening degree TA decreases smaller than the predetermined small opening degree D2, the purge cut of vapor is performed. Accordingly, vapor remaining in the intake passage 2 upstream from the electronic throttle device 6 is allowed to flow to the engine 1 until the throttle opening degree TA becomes smaller than the predetermined small opening degree D2. Thus, almost all the vapor remaining in the intake passage 2 upstream from the electronic throttle device 6 is flowed and scavenged to the engine 1. This case can result in an increase in purge flow rate of vapor.

### Third Embodiment

A detailed description of a third embodiment of an engine system embodying the present disclosure will now be given referring to the accompanying drawings.

(Purge Control During Deceleration)

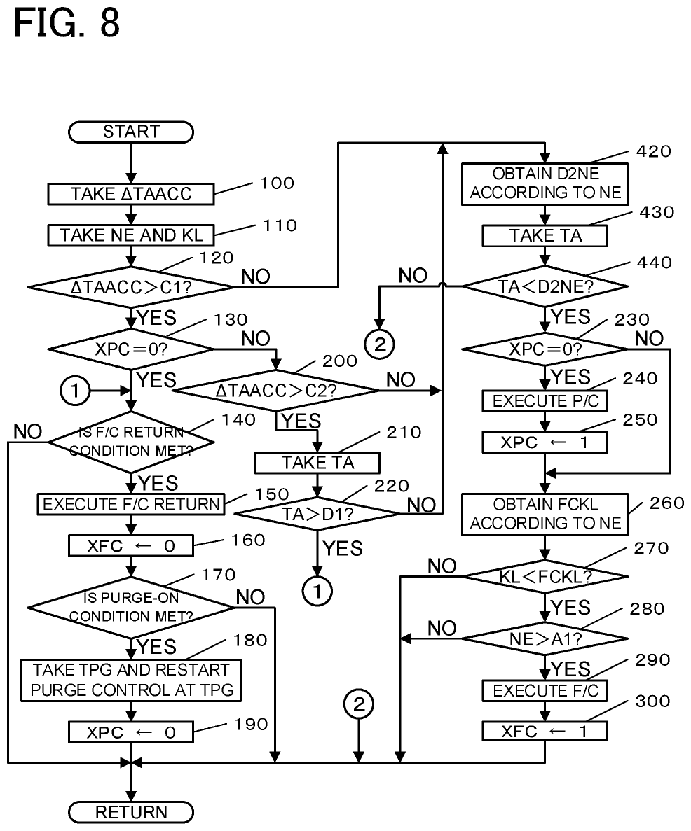

The present embodiment differs in some contents of the purge control from the second embodiment. FIG. 8 is a flowchart showing the contents of the purge control.

In the present embodiment, the flowchart in FIG. 8 differs from the flowcharts in FIGS. 3 and 6 in the processes in step 420 to step 440, which are added prior to the process in step 230.

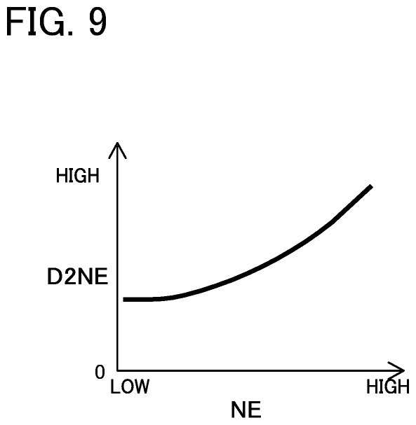

Specifically, in this routine, in step 420 following step 120, step 200, or step 220, the ECU 60 obtains a small opening degree D2NE corresponding to the engine rotation speed NE. The ECU 60 can obtain this small opening degree D2NE corresponding to the engine rotation speed NE by referring to for example a small opening degree map as shown in FIG. 9. In this map, the small opening degree D2NE is set to be higher in a curve as the engine rotation speed NE is higher.

In step 430, the ECU 60 then takes the throttle opening degree TA based on a detection value of the throttle sensor 51.

In step 440, the ECU 60 determines whether the throttle opening degree TA is smaller than the obtained small opening degree D2NE. In other words, after determining that the engine 1 has started to decelerate based on the accelerator closing speed ΔTAACC in step 120, the ECU 60 waits in step 440 for the throttle valve 6a to close smaller than the predetermined small opening degree D2NE after the start of deceleration. If this determination result is affirmative, the ECU 60 shifts the process to step 230 to carry out the vapor purge cut and the fuel cut in sequence. If the determination result is negative, in contrast, the ECU 60 returns the process to step 100.

According to the foregoing purge control, in addition to performing the control of the second embodiment, the ECU 60 is configured such that, when determining that the engine 1 has started to decelerate during operation of the engine, the ECU 60 sets the predetermined small opening degree D2NE, which is to be compared with the throttle opening degree TA, to a larger value as the engine rotation speed NE is higher.

According to the foregoing configuration of the engine system in the present embodiment, the following operations and effects can be achieved in addition to the operations and effects in the second embodiment. Specifically, the amount of vapor remaining in the intake passage 2 upstream of the electronic throttle device 6, which is caused to flow to the engine 1 during deceleration of the engine, is larger as the engine rotation speed NE is higher. In the present embodiment, when deceleration of the engine 1 is determined to have started, the predetermined small opening degree D2NE to be compared with the throttle opening degree TA is set larger as the engine rotation speed NE is higher. Thus, the timing to perform the purge cut is adjusted according to the engine rotation speed NE. This can perform the purge cut at an appropriate timing at which the vapor remaining upstream of the electronic throttle device 6 can be completely scavenged.

### Fourth Embodiment

A detailed description of a fourth embodiment of an engine system embodying the present disclosure will now be given referring to the accompanying drawings.

(Purge Control During Deceleration)

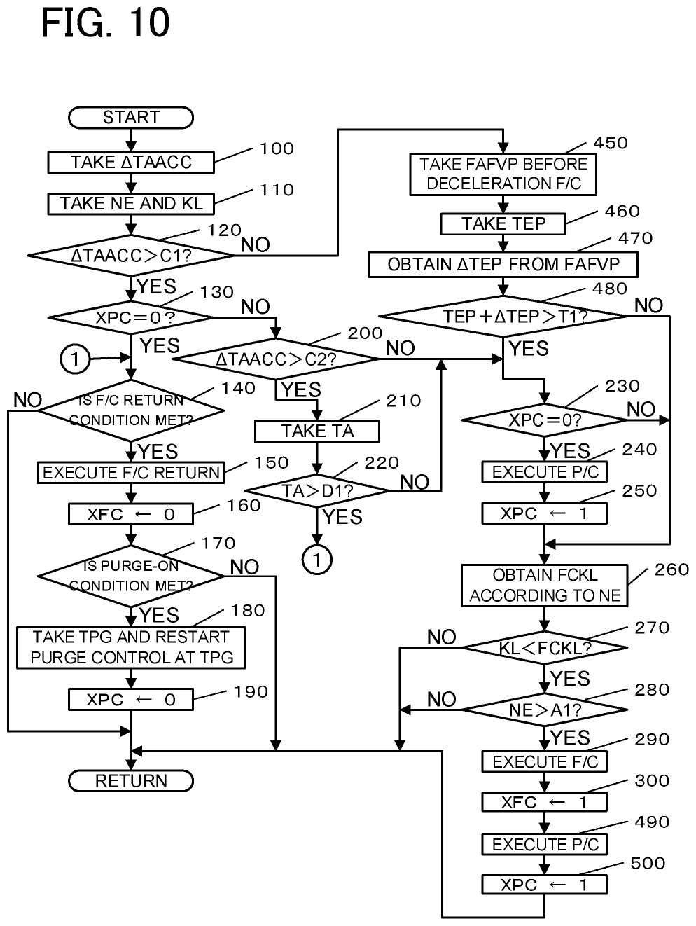

The present embodiment differs in contents of the purge control from each of the foregoing embodiments. FIG. 10 is a flowchart showing the contents of the purge control. The flowchart in FIG. 10 differs from the flowchart in FIG. 3 in the processes in step 450 to step 480, which are added between step 120 and step 230, and the processes in step 490 and step 500, which are added after step 300.

Specifically, in this routine, in step 450 following step 120, the ECU 60 takes an actual injection rate FAFVP before the deceleration fuel cut (F/C). Herein, this actual injection rate FAFVP is a value obtained in such a manner that an actual injection amount (a stoichiometric ratio) to be actually injected from the injector 17 is divided by a basic injection amount (a stoichiometric ratio) with respect to an intake amount Ga.

In step 460, the ECU 60 further takes a catalyst temperature TEP. The ECU 60 can estimate this catalyst temperature TEP based on an injection amount of fuel supplied from the injector 17 to the engine 1 and others.

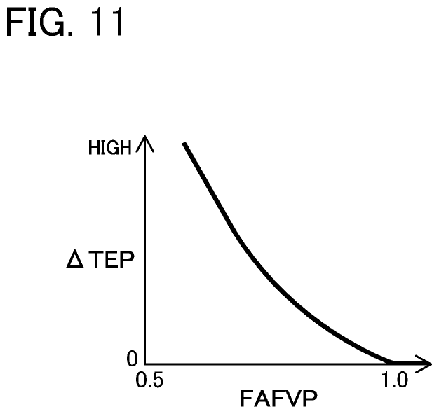

In step 470, the ECU 60 obtains an increment ΔTEP of the catalyst temperature from the taken actual injection rate FAFVP. The ECU 60 can obtain this increment ΔTEP of the catalyst temperature according to the actual injection rate FAFVP by referring to for example a catalyst temperature increment map shown in FIG. 11. In this map, the increment ΔTEP of the catalyst temperature is set to decrease in a curve as the actual injection rate FAFVP increases from 0.5 toward 1.0.

In step 480, the ECU 60 determines whether or not a result of addition of the catalyst temperature TEP and the increment ΔTEP of the catalyst temperature is higher than a predetermined reference temperature T1. This reference temperature T1 can be assigned for example 750° C. corresponding to criteria for deterioration of catalysts 10 and 11. If the determination result is affirmative, the ECU 60 shifts the process to step 230. If the determination result is negative, in contrast, the ECU 60 skips the process to step 260.

On the other hand, in step 490 following step 300, the ECU 60 performs the purge cut (P/C). Specifically, the ECU 60 controls the purge pump 44 and the purge valve 45 to cut off purging of vapor from the purge passage 43 to the intake passage 2.

In step 500, the ECU 60 further sets the purge cut execution flag XPC to 1 and then returns the process to step 100.

According to the foregoing purge control, in addition to performing the control of the first embodiment, the ECU 60 is configured such that, when determining that the engine 1 has started to decelerate during operation of the engine, the ECU 60 estimates the temperatures of the catalysts 10 and 11 based on the detected operating state of the engine 1 and controls the purge pump 44 and the purge valve 45 to perform the purge cut of vapor when the estimated temperatures of the catalysts 10 and 11 become higher than the predetermined reference temperature T1.

According to the configuration of the engine system in the present embodiment described above, the following operations and effects can be obtained in addition to the operations and effects in the first embodiment. Specifically, overheating of the catalysts 10 and 11 will be problematic mainly when the temperature of the catalysts (the sum of the catalyst temperature TEP and the increment ΔTEP of the catalyst temperature) is higher than the predetermined reference temperature T1 (e.g., corresponding to criteria for deterioration of a catalyst). Herein, the purge cut of vapor is performed when the estimated catalyst temperature TEP becomes higher than the predetermined reference temperature T1. Thus, purge cut is performed according to the temperature state of the catalysts 10 and 11. This can extend the timing to perform purge cut until the temperature which may actually cause overheating of the catalysts 10 and 11. This can result in an increase in purge flow rate of vapor.

### Fifth Embodiment

A detailed description of a fifth embodiment of an engine system embodying the present disclosure will now be given referring to the accompanying drawings.

(Purge Control During Deceleration)

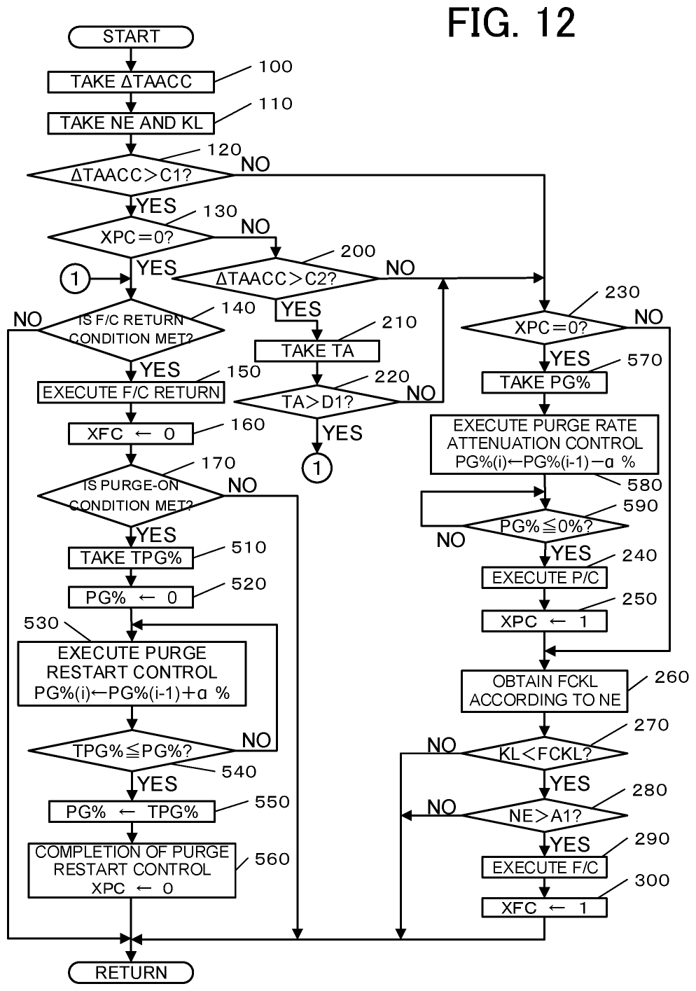

The present embodiment differs from the first embodiment in the contents of purge control. FIG. 12 is a flowchart showing the contents of the purge control. The flowchart in FIG. 12 differs from the flowchart in FIG. 3 in that step 180 and step 190 in the flowchart in FIG. 3 are omitted and, instead thereof, the processes in step 510 to step 560 are provided, and further the processes in step 570 to step 590 are added between step 230 to step 240 in the flowchart in FIG. 3.

In this routine, specifically, if the determination result in step 170 is affirmative, the ECU 60 takes a target purge rate TPG % in step 510. The ECU 60 can obtain this target purge rate TPG % based on the operating state of the engine 1.

In step 520, the ECU 60 then sets an actual purge rate PG % to 0.

In step 530, the ECU 60 obtains an actual purge rate PG % (i) by adding a predetermined value α to a previously obtained actual purge rate PG % (i−1), and performs purge restart control using the actual purge rate PG % (i). Specifically, the ECU 60 controls the purge pump 44 and the purge valve 45 so as to obtain the actual purge rate PG % (i).

In step 540, the ECU 60 further determines whether or not the target purge rate TPG % is equal to or lower than the actual purge rate PG %. If the determination result is affirmative, the ECU 60 determines that purge restart has been completed and shifts the process to step 550. If the determination result is negative, the ECU 60 determines that purge restart has not been completed and shifts the process to step 530.

In step 550, successively, the ECU 60 sets a value of the target purge rate TPG % as the actual purge rate PG %.

After judging that purge restart control has been completed, in step 560, the ECU 60 sets a purge cut execution flag XPC to 0 and returns the process to step 100.

If the determination result in step 230 is affirmative, the ECU 60 takes the actual purge rate PG % in step 570.

In step 580, the ECU 60 obtains the actual purge rate PG % (i) by subtracting the predetermined value α from the previously obtained actual purge rate PG % (i−1) and performs the purge rate attenuation control using the obtained actual purge rate PG % (i). Specifically, the ECU 60 controls the purge pump 44 and the purge valve 45 to obtain the actual purge rate PG % (i).

In step 590, the ECU 60 then determines whether or not the actual purge rate PG % is equal or lower than 0. If the determination result is affirmative, the ECU 60 determines that purge cut has been completed and thus shifts the process to step 240. If the determination result is negative, the ECU 60 determines that purge cut has not been completed yet and thus repeats the same process in step 590.

According to the foregoing purge control, in addition to performing the control of the first embodiment, the ECU 60 is configured to control the purge pump 44 and the purge valve 45 to gradually decrease the purge rate PG % of vapor in order to perform the purge cut of vapor.

According to the foregoing purge control, in addition to performing the control of the first embodiment the ECU 60 is configured to control the purge pump 44 and the purge valve 45 to gradually increase the purge rate PG % of vapor in order to restart purge.

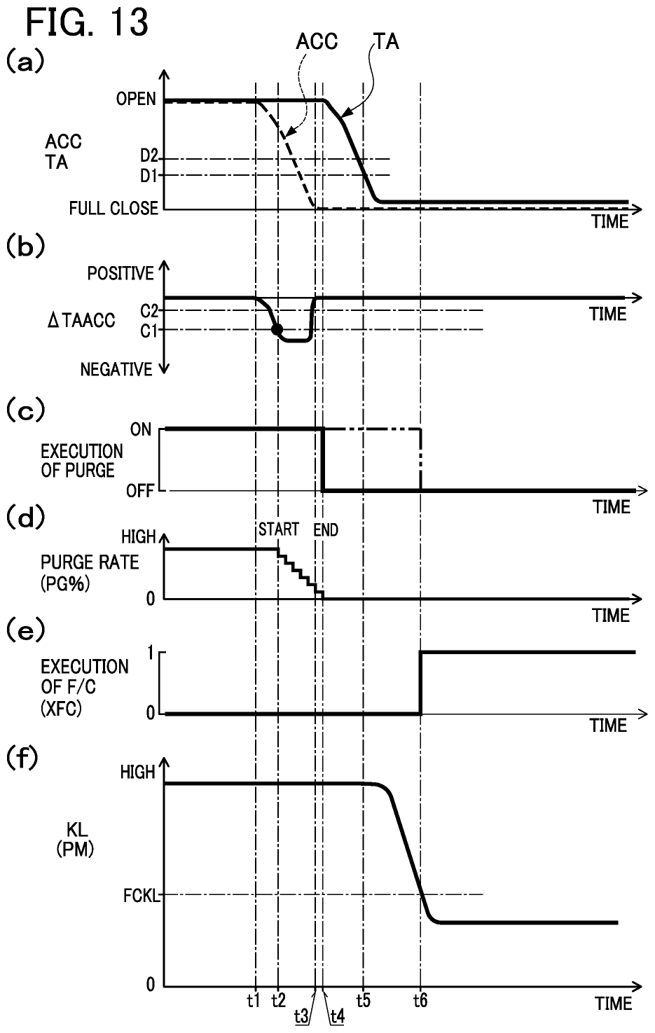

Herein, FIG. 13 is a time chart showing the behaviors of various parameters in the foregoing purge control. In FIG. 13, (a) shows changes in the accelerator opening degree ACC (a broken line) and the throttle opening degree TA (a solid line), (b) shows a change in the accelerator closing speed ΔTAACC, (c) shows a change in the execution of vapor purging, (d) shows a change in the purge rate PG %, (e) shows a change in the execution of the fuel cut (F/C) (the fuel-cut execution flag XFC), and (f) shows a change in the engine load KL (which is also a change in the intake pressure PM). In FIG. 13, after the accelerator opening degree ACC in (a) starts to decrease at time t1, when the accelerator closing speed ΔTAACC in (b) falls below the first deceleration determination value C1 at time t2, the purge rate PG % in (d) starts to decrease (the purge cut starts). When the purge rate PG % in (d) reaches 0 at time t4 (i.e., when the purge cut is completed), the purge execution in (c) is turned off, that is, purge cut is performed. Thereafter, the throttle opening degree TA starts to decrease with a delay from when the accelerator opening degree ACC comes to a full close degree. While the throttle opening degree TA in (a) having reached a minimum deceleration opening degree remains thereat, when the engine load KL in (f) falls below a fuel cut execution load FCKL at time t6, the fuel cut (F/C) in (e) is executed. As seen in FIG. 13, when deceleration of the engine 1 is determined to have started based on the change rate of the accelerator opening degree ACC (i.e., the accelerator closing speed ΔTAACC), the purge cut for gradually decreasing the purge rate PG % is started. Thereafter, when the engine load KL falls within the fuel cut execution load FCKL while the throttle valve 6a remains closed at the deceleration opening degree after having been closed thereto with a delay from when the accelerator opening degree ACC has come to the full close degree, the fuel cut is executed at once.

According to the configuration of the engine system in the present embodiment described above, the following operations and effects can be achieved in addition to the operations and effects in the first embodiment. Since the intake passage 2 upstream of the electronic throttle device 6 has a relatively large volume, if the vapor purge cut is executed at once, it is difficult to predict the timing at which intake air remaining in the intake passage 2 upstream of the electronic throttle device 6 after the purge cut will flow to the engine 1. On the other hand, the engine 1 is operated by the fuel injected from the injector 17 and the purged vapor. Thus, if the vapor is cleared out at once by execution of the purge cut, the air-fuel ratio becomes over-lean, which may cause misfire in the engine 1 and a rise in the temperature of the catalysts 10 and 11. Herein, the purge PG % is adjusted to gradually decrease when the purge cut of vapor is executed, so that the vapor which may flow to the engine 1 is not cleared out at once. This can prevent the air-fuel ratio from becoming over-lean or the temperature of the catalysts 10 and 11 from rising due to execution of the purge cut during deceleration of the engine.

According to the configuration in the present embodiment, the purge rate PG % is adjusted to gradually increase when the purging of vapor is restarted. Thus, the vapor allowed to flow to the engine 1 is not increased at once. This can prevent the air-fuel ratio from becoming over-rich or the exhaust emission from deteriorating due to purge restart during operation of the engine.

### Sixth Embodiment

A detailed description of a sixth embodiment of an engine system embodying the present disclosure will now be given referring to the accompanying drawings.

(Purge Control During Deceleration)

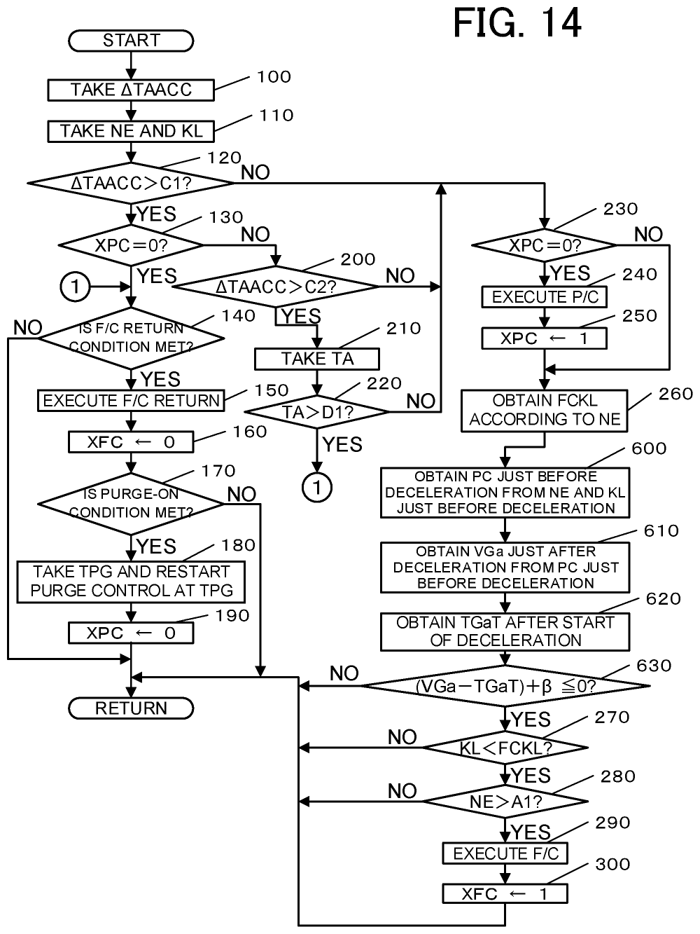

The present embodiment differs in contents of the purge control from each of the foregoing embodiments. FIG. 14 is a flowchart showing the contents of the purge control. The flowchart in FIG. 14 differs from the flowchart in FIG. 3 in that additional step 600 to step 630 are provided between step 260 and step 270 in the flowchart in FIG. 3.

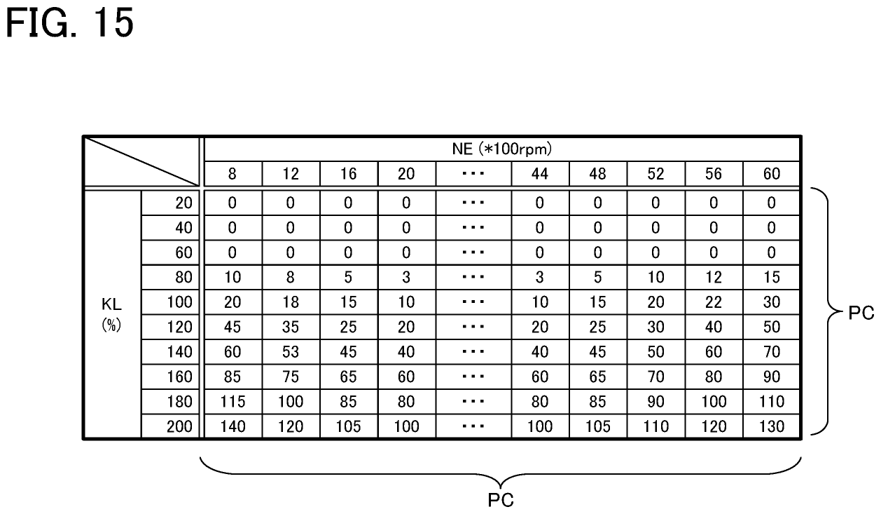

In this routine, specifically, in step 600 following step 260, the ECU 60 obtains an outlet pressure PC of the compressor 5a (a compressor outlet pressure) just before deceleration based on the engine rotation speed NE and the engine load KL just before deceleration. The ECU 60 can obtain the compressor outlet pressure PC just before deceleration according to the engine rotation speed NE and the engine load KL just before deceleration by referring to for example an outlet pressure map shown in FIG. 15.

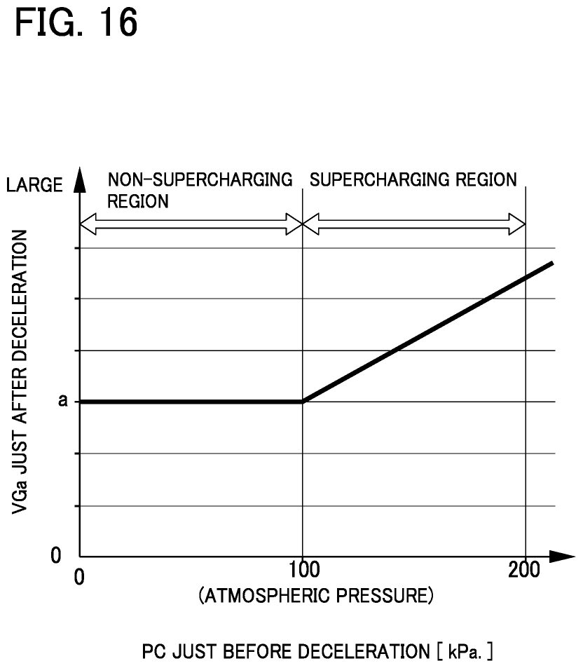

In step 610, the ECU 60 then obtains a residual intake amount VGa just after deceleration based on the compressor outlet pressure PC just before deceleration. The residual intake amount VGa means the amount of intake air containing vapor remaining in the intake passage 2 upstream of the electronic throttle device 6 (the throttle valve 6a). Herein, FIG. 16 is a graph showing a relationship of the residual intake amount VGa just after deceleration with respect to the compressor outlet pressure PC just before deceleration. As shown in FIG. 16, in a non-supercharging region from low pressure to atmospheric pressure, the residual intake amount VGa is a predetermined constant a, irrespective of the compressor outlet pressure PC. In a supercharging region, the residual intake amount VGa linearly increases as the compressor outlet pressure PC increases. The ECU 60 can obtain the residual intake amount VGa just after deceleration according to the compressor outlet pressure PC just before deceleration by referring to a characteristic map corresponding to the characteristics in the graph shown in FIG. 16.

In step 620, the ECU 60 obtains an integrated passing intake amount TGaT of intake air having passed through the throttle valve 6a after the start of deceleration. The ECU 60 can obtain this integrated passing intake amount TGaT by integrating the intake amount Ga per unit time detected by the air flow meter 52 from the start of deceleration.

In step 630, the ECU 60 determines whether or not a calculated value obtained by adding a predetermined value β to a difference between the residual intake amount VGa and the integrated passing intake amount TGaT is equal to or less than 0. Herein, the ECU 60 determines a scavenging status of residual intake air in the intake passage 2 upstream of the electronic throttle device 6. If the determination result is affirmative, the ECU 60 determines that the residual intake air has been completely scavenged and thus shifts the process to step 270. If the determination result is negative, the ECU 60 determines that the residual intake air has not been completely scavenged yet and thus returns the process to step 100.

According to the foregoing purge control, in addition to performing the control of the first embodiment, the ECU 60 is configured to control the purge pump 44 and the purge valve 45 for the purge cut of vapor and then obtain the amount of residual intake air VGa (the residual intake amount) containing vapor remaining in the intake passage 2 upstream of the electronic throttle device 6 based on the detected operating state of the engine 1, and further control the injector 17 to perform fuel cut after determining that the obtained amount of residual intake air has been completely scavenged.

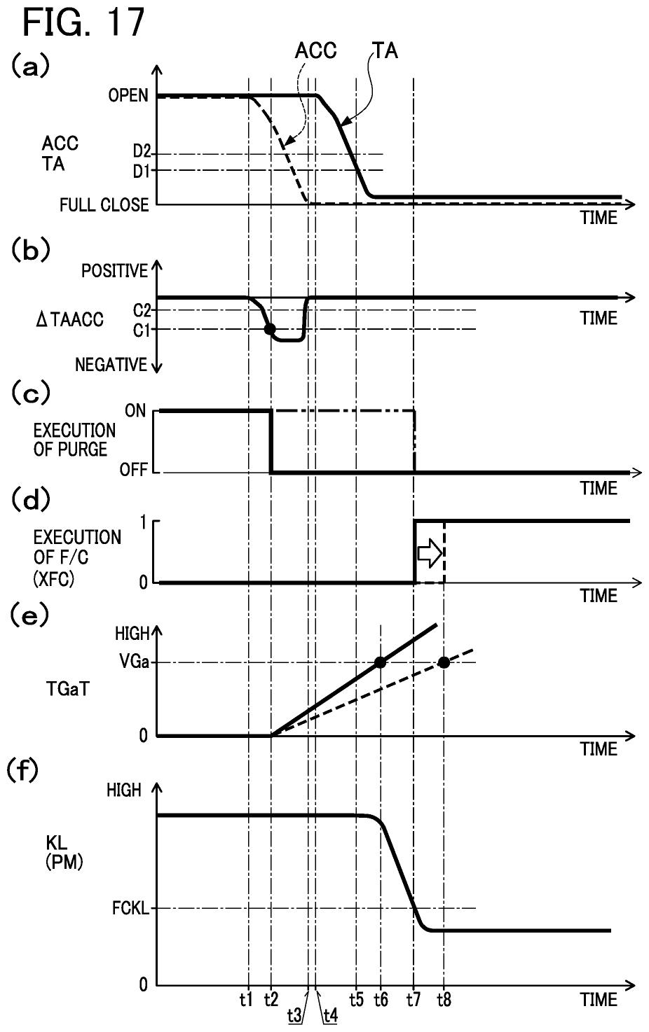

Herein, FIG. 17 is a time chart showing behaviors of various parameters in the foregoing purge control. In FIG. 17, (a) shows changes in the accelerator opening degree ACC (a broken line) and the throttle opening degree TA (a solid line), (b) shows a change in the accelerator closing speed ΔTAACC, (c) shows a change in the execution of vapor purging, (d) shows a change in the execution of the fuel cut (F/C) (the fuel-cut execution flag XFC), (e) shows a change in the integrated passing intake amount TGaT (a decrease in the residual intake amount VGa), and (f) shows a change in the engine load KL (which is also a change in the intake pressure PM). In FIG. 17, after the accelerator opening degree ACC in (a) starts to decrease at time t1, when the accelerator closing speed ΔTAACC in (b) falls below the first deceleration determination value C1 at time t2, the purge execution in (c) is turned off at once, that is, the purge cut is performed. Thus, the integrated passing intake amount TGaT in (e) starts to increase (the residual intake amount VGa starts to decrease). Subsequently, after the integrated passing intake amount TGaT has reached the residual intake amount VGa (the residual intake amount VGa has been completely scavenged) at time t6, when the engine load KL in (f) falls below the fuel cut execution load FCKL at time t7 while the throttle opening degree TA in (a) having reached the minimum deceleration opening degree remains thereat, the fuel cut (F/C) in (d) is performed. Herein, if an increase in the integrated passing intake amount TGaT is delayed as indicated by a broken line in (e), the execution of the fuel cut is delayed until time t8 as indicated by the broken line in (d). As seen in FIG. 17, the purge cut is performed at once when deceleration of the engine 1 is determined to have started based on a change rate of the accelerator opening degree ACC (the accelerator closing speed ΔTAACC). Thereafter, after the residual intake amount VGa decreases and the residual intake air is cleared out (completion of scavenging), when the engine load KL falls below the fuel cut execution load FCKL while the throttle valve 6a remains closed at the deceleration opening degree after having been closed thereto with a delay from when the accelerator opening degree ACC has come to the full close degree, the fuel cut is performed at once.

According to the configuration of the engine system in the present embodiment described above, the following operations and effects can be obtained in addition to the operations and effects in the first embodiment. Specifically, after the purge cut of vapor is performed, the residual intake amount VGa of the intake air containing vapor remaining in the intake passage 2 upstream of the electronic throttle device 6 is obtained, and that amount VGa of the residual intake air is scavenged and then the fuel cut is executed. Accordingly, the fuel cut is performed after the purge cut is carried out and the residual intake air containing vapor is cleared out of the intake passage 2 upstream of the electronic throttle device 6. This can reliably prevent the vapor from flowing from the engine 1 to the catalysts 10 and 11 when the fuel cut is to be executed during deceleration of the engine 1, which can prevent an excessive rise of the temperature of the catalysts 10 and 11 with high accuracy.

### Seventh Embodiment

A detailed description of a seventh embodiment of an engine system embodying the present disclosure will now be given referring to the accompanying drawings.

(Purge Control During Deceleration)

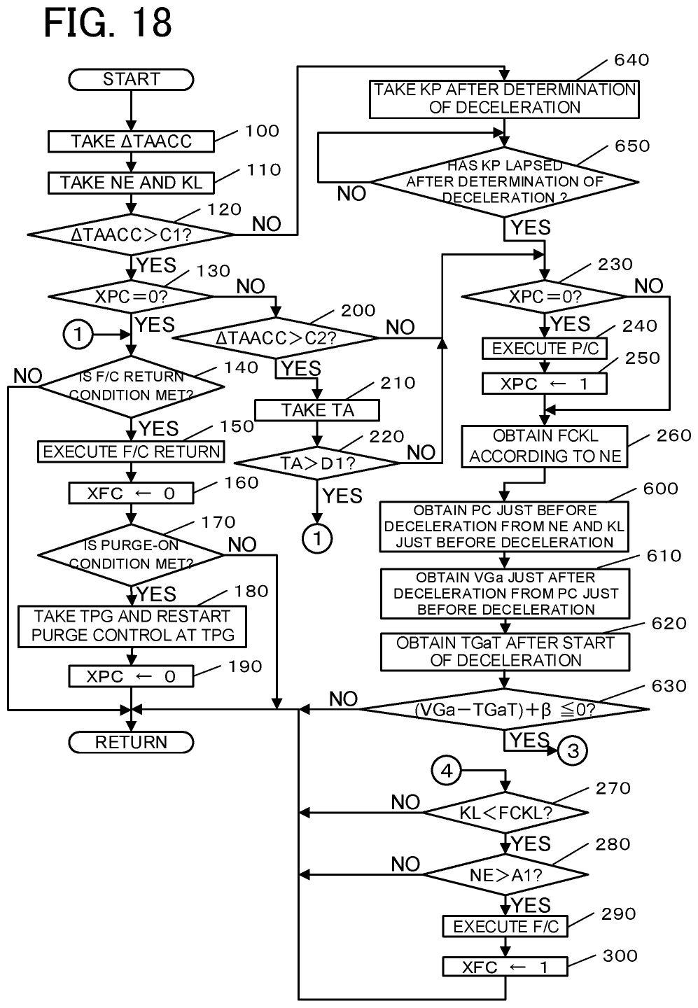

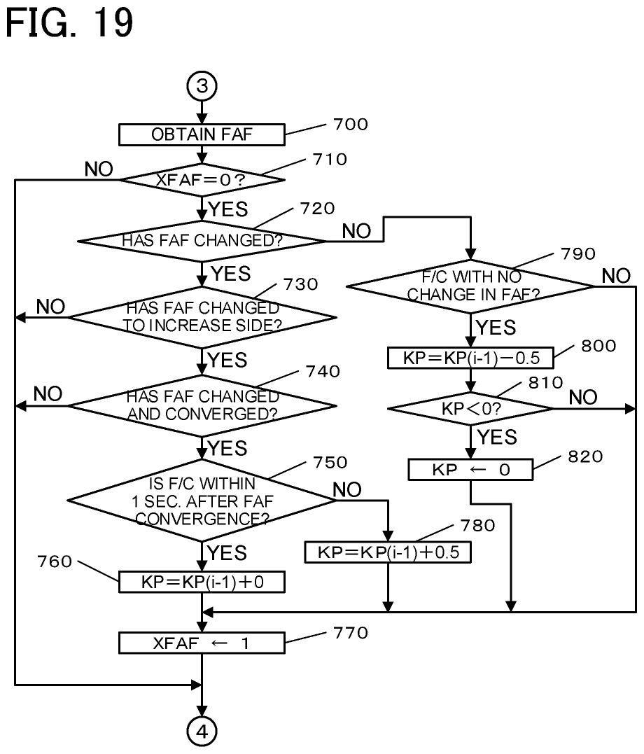

The present embodiment differs in contents of the purge control from the sixth embodiment. FIGS. 18 and 19 are flowcharts showing the contents of the purge control. The flowcharts in FIGS. 18 and 19 differ from the flowchart in FIG. 14 in the processes in step 640 to step 650, which are added between step 120 and step 230, and the processes in step 700 to step 820, which are added between step 630 and step 270 in FIG. 14.

Specifically, in this routine, if the determination result in step 120 is negative, the ECU 60 takes a purge cut delay time KP in step 640 after determining deceleration in step 120.

In step 650, successively, the ECU 60 waits for a lapse of the purge cut delay time KP after determining deceleration and then shifts the process to step 230.

In this routine, on the other hand, if the determination result in step 630 is affirmative, the ECU 60 obtains a stoichiometric air-fuel-ratio correction coefficient FAF in step 700. The ECU 60 can this stoichiometric air-fuel-ratio correction coefficient FAF based on an oxygen concentration Ox detected by the oxygen sensor 56 in the air-fuel ratio control for the engine 1, which is separately executed.

In step 710, the ECU 60 then determines whether or not an air-fuel-ratio correction flag XFAF is 0. This flag XFAF is set to 1 when the air-fuel-ratio correction coefficient FAF converges to a certain value by the purge cut of vapor, as will be described later. If the determination result is affirmative, the ECU 60 advances the process to step 720. If the determination result is negative, the ECU 60 skips the process to step 270.

In step 720, the ECU 60 determines whether or not the air-fuel-ratio correction coefficient FAF has changed. The ECU 60 advances the process to step 730 if the determination result is affirmative, but shifts the process to step 790 if the determination result is negative.

In step 730, the ECU 60 determines whether or not the air-fuel-ratio correction coefficient FAF has changed to an increase side. If the determination result is affirmative, the ECU 60 advances the process to step 740. If the determination result is negative, the ECU 60 skips the process to step 270.

In step 740, the ECU 60 then determines whether or not the air-fuel-ratio correction coefficient FAF has changed and converged to a certain value. If the determination result is affirmative, the ECU 60 advances the process to step 750. If the determination result is negative, the ECU 60 skips the process to step 270.

In step 750, the ECU 60 determines whether or not the fuel cut (F/C) has been executed within 1 second upon completion of convergence of the air-fuel-ratio correction coefficient FAF. If this determination result is affirmative, the ECU 60 advances the process to step 760. If the determination result is negative, the ECU 60 shifts the process to step 780.

In step 760, the ECU 60 calculates the purge cut delay time KP. Herein, a previous purge cut delay time KP(i−1) is assumed as a present purge cut delay time KP.

In step 770, the ECU 60 sets the air-fuel-ratio correction coefficient FAF to 1 and then shifts the process to step 270.

In step 780 following step 750, on the other hand, the ECU 60 calculates a purge cut delay time KP. Herein, a result obtained by adding 0.5 seconds to the previous purge cut delay time KP(i−1) is assumed as the present purge cut delay time KP. This additional value, 0.5 seconds, is one example. Thereafter, the ECU 60 shifts the process to step 770.

In step 790 following step 720, in contrast, the ECU 60 determines whether or not the fuel cut (F/C) has been performed while the air-fuel-ratio correction coefficient FAF remains unchanged. If the determination result is affirmative, the ECU 60 advances the process to step 800. If the determination result is negative, the ECU 60 shifts the process to step 770.

In step 800, the ECU 60 calculates the purge cut delay time KP. Herein, a result obtained by subtracting 0.5 seconds from the previous purge cut delay time KP(i−1) is assumed as the present purge cut delay time KP. This subtractive value, 0.5 seconds, is one example.

In step 810, the ECU 60 then determines whether or not the purge cut delay time KP is smaller than 0, i.e., a negative value. If the determination result is affirmative, the ECU 60 advances the process to step 820. If the determination result is negative, the ECU 60 skips the process to step 770.

In step 820, the ECU 60 sets the purge cut delay time KP to 0 and then shifts the process to step 770.

According to the foregoing purge control, in addition to performing the control of the sixth embodiment, the ECU 60 is configured to obtain the purge cut delay time KP for delaying the purge cut of vapor based on the change in detected air-fuel ratio (the air-fuel-ratio correction coefficient FAF) and controls the purge pump 44 and the purge valve 45 to perform the purge cut of vapor after a lapse of the purge cut delay time KP when determining that the engine 1 has started to decelerate during operation of the engine 1.

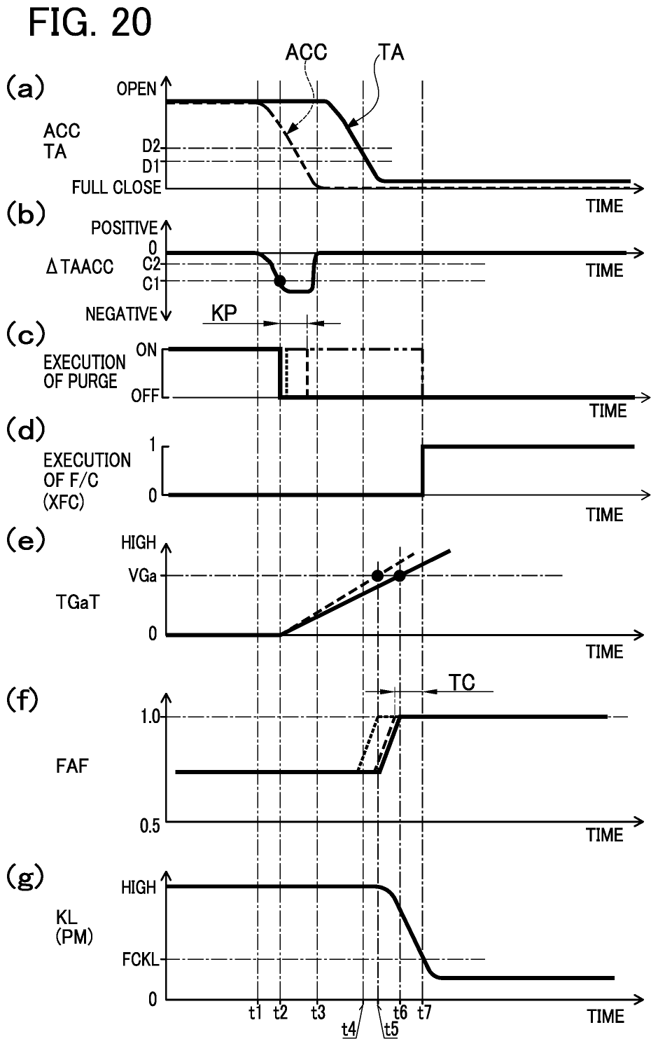

Herein, FIG. 20 is a time chart showing the behaviors of various parameters in the foregoing purge control. In FIG. 20, (a) shows changes in the accelerator opening degree ACC (a broken line) and the throttle opening degree TA (a solid line), (b) shows a change in the accelerator closing speed ΔTAACC, (c) shows a change in the execution of vapor purging, (d) shows a change in the execution of the fuel cut (F/C) (the fuel-cut execution flag XFC), (e) shows a change in the integrated passing intake amount TGaT (a decrease in the residual intake amount VGa), (f) shows a change in the air-fuel ratio correction coefficient FAF, and (g) shows a change in the engine load KL (which is also a change in the intake pressure PM). In FIG. 20, after the accelerator opening degree ACC in (a) starts to decrease at time t1, when the accelerator closing speed ΔTAACC in (b) falls below the first deceleration determination value C1 at time t2, the purge execution in (c) is turned off at once, that is, the purge cut is performed. Thus, the integrated passing intake amount TGaT in (e) starts to increase (the residual intake amount VGa starts to decrease). Subsequently, after the integrated passing intake amount TGaT has reached the residual intake amount VGa (the residual intake amount VGa has been completely scavenged) at time t6, when the engine load KL in (g) falls below the fuel cut execution load FCKL at time t7 while the throttle opening degree TA in (a) having reached the minimum deceleration opening degree remains thereat, the fuel cut (F/C) in (d) is performed. Herein, when a post-convergence time TC (i.e., a period of time from when the air-fuel ratio correction coefficient FAF converges to 1.0 to when execution of the fuel cut is started) in (f) is 1 second or more, the timing to perform a next purge cut is delayed by a predetermined time (the purge cut delay time KP). As seen in FIG. 20, differently from FIG. 17, if convergence of the air-fuel ratio of the engine 1 is delayed depending on a scavenging status of the intake air (the residual intake air) containing vapor remaining in the intake passage 2 upstream of the electronic throttle device 6 during deceleration of the engine 1, the timing to perform a next purge cut is delayed by the purge cut delay time KP from the time of determining the start of deceleration.

According to the configuration of the engine system in the present embodiment described above, the following operations and effects can be obtained in addition to the operations and effects in the sixth embodiment. Specifically, herein, if the purge cut starts to be executed too early, it leads to a decrease in purge flow rate to be supplied to the engine 1. In contrast, if the purge cut starts to be executed too late, it leads to a rise in catalyst temperature. Herein, the timing of the temperature rise of the catalysts 10 and 11 due to inflow of the vapor is predicted by the purge cut delay time KP based on a change in air-fuel ratio of the engine 1. After a lapse of the purge cut delay time KP, the purge cut of vapor is executed. Therefore, the timing to execute the purge cut is adjusted in accordance with the timing of the temperature rise of the catalysts 10 and 11. This can optimize the timing to execute the purge cut according to the temperature rise of the catalysts 10 and 11, and hence can both prevent a decrease in purge flow rate and prevent a rise in temperature of the catalysts 10 and 11.

The present disclosure is not limited to the foregoing embodiments and may be embodied partly in other specific forms without departing from the essential characteristics thereof.

(1) In each of the foregoing embodiments, the deceleration of the engine 1 is determined to have started based on the accelerator closing speed ΔTAACC, which is a change rate of the accelerator opening degree ACC. As an alternative, the start of deceleration of the engine 1 can be determined based on a change rate of the throttle opening degree TA detected by the accelerator sensor 57.

(2) Each of the foregoing embodiments embodies this engine system as an engine system equipped with no EGR device; however, the engine system may be embodied as an engine system equipped with an EGR device.

### INDUSTRIAL APPLICABILITY

The present disclosure is available for an engine system provided with an engine, a supercharger, an intake amount regulating valve, and an evaporated fuel treatment apparatus.

### REFERENCE SIGNS LIST

1 Engine
2 Intake passage
3 Exhaust passage
5 Supercharger
5a Compressor
5b Turbine
5c Rotary shaft
6 Electronic throttle device (Intake amount regulating valve)
6a Throttle valve
10 Catalyst
11 Catalyst
16 Accelerator pedal (Output operating unit)
17 Injector (Fuel supply device)
40 Fuel tank (Fuel supply device)
41 Evaporated fuel treatment apparatus
42 Canister
43 Purge passage
43a Outlet
44 Purge pump (Purge adjusting unit)
45 Purge valve (Purge adjusting unit)
46 Vapor passage
51 Throttle sensor (Operating state detecting unit, Valve opening degree detecting unit)
52 Air flow meter (Operating state detecting unit)
53 Intake pressure sensor (Operating state detecting unit)
54 Water temperature sensor (Operating state detecting unit)
55 Rotation speed sensor (Operating state detecting unit, Rotation speed detecting unit)
56 Oxygen sensor (Operating state detecting unit, Air-fuel ratio detecting unit)
57 Accelerator sensor (Operating state detecting unit, Output operation amount detecting unit)
58 Vehicle speed sensor (Operating state detecting unit)
60 ECU (Controller)

1. An engine system comprising:
an engine;
an intake passage configured to introduce intake air into the engine;
an exhaust passage configured to discharge exhaust gas from the engine;
a fuel supply device including a fuel tank for storing fuel and an injector for injecting the fuel stored in the fuel tank, the fuel supply device being configured to supply the fuel to the engine;
an intake amount regulating valve placed in the intake passage and configured to regulate an amount of the intake air flowing through the intake passage;
a supercharger including a compressor placed in the intake passage, a turbine placed in the exhaust passage, and a rotary shaft connecting the compressor and the turbine in an integrally rotatable manner, the supercharger being configured to increase pressure of the intake air in the intake passage;
an evaporated fuel treatment apparatus comprising: a canister configured to temporarily collect evaporated fuel generated in the fuel tank; a purge passage configured to purge the evaporated fuel collected in the canister to the intake passage, the purge passage having an outlet connected to the intake passage upstream of the compressor; and a purge regulating unit configured to regulate an amount of the evaporated fuel to be purged from the purge passage to the intake passage, the evaporated fuel treatment apparatus being configured to treat the evaporated fuel;
an operating-state detecting unit configured to detect an operating state of the engine; and
a controller configured to control at least the injector, the intake amount regulating valve, and the purge regulating unit according to the detected operating state of the engine,
wherein, during operation of the engine, when the controller determines that the engine has started to decelerate based on the detected operating state of the engine, the controller is configured to control the purge regulating unit to cut off purging of the evaporated fuel from the purge passage to the intake passage and then control the injector to cut off supply of the fuel to the engine.

2. The engine system according to claim 1, wherein after controlling the purge adjusting unit to cut off purging of the evaporated fuel, the controller is configured to control the injector to cut off supply of the fuel when determining that the engine has reached a predetermined operating state.

3. The engine system according to claim 1, wherein after controlling the purge adjusting unit to cut off purging of the evaporated fuel, the controller is configured to obtain an amount of residual intake air containing the evaporated fuel remaining in the intake passage upstream of the intake amount regulating valve based on the detected operating state, and control the injector to cut off supply of the fuel when determining that the obtained amount of the residual intake air is completely scavenged.

4. The engine system according to claim 1, wherein the controller is configured to estimate a temperature of the catalyst based on the detected operating state of the engine when determining that the engine has started to decelerate during operation of the engine, and control the purge regulating unit to cut off purging of the evaporated fuel when the estimated temperature of the catalyst rises higher than a predetermined reference temperature.

5. The engine system according to claim 1, wherein
the operating-state detecting unit includes an air-fuel ratio detecting unit configured to detect an air-fuel ratio of the engine, and
the controller is configured to obtain a delay time for delaying cut-off of purging of the evaporated fuel based on a change in the detected air-fuel ratio and control the purge regulating unit to cut off purging of the evaporated fuel after a lapse of the delay time when determining that the engine has started to decelerate during operation of the engine.

6. The engine system according to claim 1, wherein the controller is configured to control the purge regulating unit to gradually decrease a purge rate of the evaporated fuel when purging of the evaporated fuel is to be cut off.

7. The engine system according to claim 6, wherein the controller is configured to control the purge regulating unit to gradually increase the purge rate of the evaporated fuel when purging of the evaporated fuel is to be restarted after purging of the evaporated fuel is cut off.

8. The engine system according to claim 1 further comprising an output operation unit to be operated by a driver to control output of the engine,
wherein the operating-state detecting unit includes: an output operation amount detecting unit configured to detect an operation amount of the output operation unit; and a valve opening degree detecting unit configured to detect an opening degree of the intake amount regulating valve, and
the controller is configured to determine that the engine has started to decelerate based on at least one of a change rate of the detected operation amount and a change rate of the detected opening degree.

9. The engine system according to claim 8, wherein the controller is configured to control the purge regulating unit to cut off purging of the evaporated fuel when determining both that the engine has started to decelerate based on the change rate of the detected operation amount and that the detected opening degree is smaller than a predetermined small opening degree.

10. The engine system according to claim 9, wherein
the operating-state detecting unit includes a rotation speed detecting unit configured to detect a rotation speed of the engine, and
the controller is configured to set the predetermined small opening degree larger as the detected rotation speed is higher.

11. The engine system according to claim 2, wherein after controlling the purge adjusting unit to cut off purging of the evaporated fuel, the controller is configured to obtain an amount of residual intake air containing the evaporated fuel remaining in the intake passage upstream of the intake amount regulating valve based on the detected operating state, and control the injector to cut off supply of the fuel when determining that the obtained amount of the residual intake air is completely scavenged.

12. The engine system according to claim 2, wherein the controller is configured to estimate a temperature of the catalyst based on the detected operating state of the engine when determining that the engine has started to decelerate during operation of the engine, and control the purge regulating unit to cut off purging of the evaporated fuel when the estimated temperature of the catalyst rises higher than a predetermined reference temperature.

13. The engine system according to claim 2, wherein
the operating-state detecting unit includes an air-fuel ratio detecting unit configured to detect an air-fuel ratio of the engine, and
the controller is configured to obtain a delay time for delaying cut-off of purging of the evaporated fuel based on a change in the detected air-fuel ratio and control the purge regulating unit to cut off purging of the evaporated fuel after a lapse of the delay time when determining that the engine has started to decelerate during operation of the engine.

14. The engine system according to claim 2, wherein the controller is configured to control the purge regulating unit to gradually decrease a purge rate of the evaporated fuel when purging of the evaporated fuel is to be cut off.

15. The engine system according to claim 14, wherein the controller is configured to control the purge regulating unit to gradually increase the purge rate of the evaporated fuel when purging of the evaporated fuel is to be restarted after purging of the evaporated fuel is cut off.

16. The engine system according to claim 2 further comprising an output operation unit to be operated by a driver to control output of the engine,
wherein the operating-state detecting unit includes: an output operation amount detecting unit configured to detect an operation amount of the output operation unit; and a valve opening degree detecting unit configured to detect an opening degree of the intake amount regulating valve, and
the controller is configured to determine that the engine has started to decelerate based on at least one of a change rate of the detected operation amount and a change rate of the detected opening degree.

17. The engine system according to claim 16, wherein the controller is configured to control the purge regulating unit to cut off purging of the evaporated fuel when determining both that the engine has started to decelerate based on the change rate of the detected operation amount and that the detected opening degree is smaller than a predetermined small opening degree.

18. The engine system according to claim 17, wherein
the operating-state detecting unit includes a rotation speed detecting unit configured to detect a rotation speed of the engine, and
the controller is configured to set the predetermined small opening degree larger as the detected rotation speed is higher.
